(19) United States
(12) Patent Application Publication
(10) Pub. No.: US 2019/0062856 A1
(43) Pub. Date: Feb. 28, 2019

(54) METHODS FOR CHROMIUM COATING

(71) Applicant: Arcanum Alloys, Inc., Sunnyvale, CA (US)

(72) Inventors: Joseph E. McDermott, Sunnyvale, CA (US); Adam G. Thomas, Sunnyvale, CA (US); Zachary M. Detweiler, Sunnyvale, CA (US)

(21) Appl. No.: 16/121,280

(22) Filed: Sep. 4, 2018

Related U.S. Application Data
(63) Continuation of application No. PCT/US2017/021281, filed on Mar. 8, 2017.
(60) Provisional application No. 62/305,453, filed on Mar. 8, 2016.

(51) Int. Cl. C21D 1/26; B05D 1/28; B05D 3/00

(52) U.S. Cl. CPC C21D 1/26; B05D 2202/10; B05D 3/007; B05D 1/28

(57) ABSTRACT

The present disclosure provides methods for forming a metal layer adjacent to a substrate, comprising providing a substrate comprising carbon at a concentration of at least about 0.001 wt % and one or more of silicon, manganese, titanium, vanadium, aluminum and nitrogen, and depositing a first layer comprising a metal adjacent to the substrate. Next, the first layer and the substrate may be subjected to annealing under conditions that are sufficient to generate a second layer from the first layer adjacent to the substrate. The second layer may comprise the carbon and the metal as a metal carbide.

### CROSS-REFERENCE

This application is a continuation application of International Patent Application No. PCT/US2017/021281, filed on Mar. 8, 2017, which claims priority to U.S. Provisional Patent Application Ser. No. 62/305,453, filed Mar. 8, 2016, each of which is entirely incorporated herein by reference.

### BACKGROUND

Steel can be an alloy of iron and other elements, including carbon. When carbon is the primary alloying element, its content in the steel may be between 0.002% and 2.1% by weight. Without limitation, the following elements can be present in steel: carbon, manganese, phosphorus, sulfur, silicon, and traces of oxygen, nitrogen and aluminum. Alloying elements added to modify the characteristics of steel can include without limitation: manganese, nickel, chromium, molybdenum, boron, titanium, vanadium and niobium.

Stainless steel can be a material that does not readily corrode, rust (or oxidize) or stain with water. There can be different grades and surface finishes of stainless steel to suit a given environment. Stainless steel can be used where both the properties of steel and resistance to corrosion are beneficial.

### SUMMARY

The present disclosure provides systems and methods for forming material layers using slurries. Examples of such material layers include but are not limited to stainless steel, silicon steel, and noise vibration harshness damping steel.

The present disclosure provides systems and methods that employ slurries to form layers adjacent to substrates. Such layers can include, for example, one or more of iron, chromium, nickel, silicon, vanadium, titanium, boron, tungsten, aluminum, molybdenum, cobalt, manganese, zirconium, and niobium, oxides thereof, nitrides thereof, sulfides thereof, or combinations thereof.

In an aspect, the present disclosure provides a method for forming a metal-containing part, comprising: (a) providing a substrate comprising carbon at a concentration of at least about 0.001 wt % and one or more of silicon, manganese, titanium, vanadium, aluminum and nitrogen, as measured by x-ray photoelectron spectroscopy (XPS); (b) depositing a first layer comprising a metal adjacent to the substrate; and (c) subjecting the first layer and the substrate to annealing under conditions that are sufficient to generate a second layer from the first layer adjacent to the substrate, thereby forming the metal-containing part comprising the second layer and the substrate, wherein the second layer comprises the carbon and the metal as a metal carbide.

In some embodiments, the second layer comprises domains of the metal carbide. In some embodiments, the second layer comprises domains without the metal carbide. In some embodiments, the first layer is deposited using a slurry comprising the metal.

In some embodiments, the slurry comprises an alloying agent, a metal halide activator and a solvent, and wherein the alloying agent comprises the metal. In some embodiments, the alloying agent comprises carbon. In some embodiments, the metal halide activator comprises a monovalent metal, a divalent metal or a trivalent metal. In some embodiments, the metal halide activator is selected from the group consisting of magnesium chloride (MgCl₂), iron (II) chloride (FeCl₂), calcium chloride (CaCl₂), zirconium (IV) chloride (ZrCl₄), titanium (IV) chloride (TiCl₄), niobium (V) chloride (NbCl₅), titanium (III) chloride (TiCl₃), silicon tetrachloride (SiCl₄), vanadium (III) chloride (VCl₃), chromium (III) chloride (CrCl₃), trichlorosilance (SiHCl3), manganese (II) chloride (MnCl₂), chromium (II) chloride (CrCl₂), cobalt (II) chloride (CoCl₂), copper (II) chloride (CuCl₂), nickel (II) chloride (NiCl₂), vanadium (II) chloride (VCl₂), ammonium chloride (NH₄Cl), sodium chloride (NaCl), potassium chloride (KCl), molybdenum sulfide (MoS), manganese sulfide (MnS), iron disulfide (FeS₂), chromium sulfide (CrS), iron sulfide (FeS), copper sulfide (CuS), nickel sulfide (NiS) and combinations thereof.

In some embodiments, the slurry comprises an inert species. In some embodiments, the inert species is selected from the group consisting of alumina (Al₂O₃), silica (SiO₂), titanium dioxide (TiO₂), magnesium oxide (MgO), calcium oxide (CaO), a clay and combinations thereof.

In some embodiments, the solvent is an aqueous solvent. In some embodiments, the solvent is an organic solvent. In some embodiments, the solvent comprises an inorganic binder. In some embodiments, the inorganic binder is sodium silicate. In some embodiments, the solvent comprises an organic binder. In some embodiments, the organic binder is methyl cellulose or polyethylene oxide (PEO).

In some embodiments, the metal comprises one or more of iron, chromium, nickel, silicon, vanadium, titanium, boron, tungsten, aluminum, molybdenum, cobalt, manganese, zirconium and niobium. In some embodiments, the first layer is deposited by vapor deposition. In some embodiments, the first layer is deposited by electrochemical deposition. In some embodiments, the substrate comprises steel. In some embodiments, the first layer has a pattern or morphology that facilitates formation of the metal carbide. In some embodiments, the method further comprising selecting the pattern or morphology prior to (b).

In some embodiments, the carbon is at a concentration of at least about 0.01 wt % as measured by XPS. In some embodiments, the carbon is at a concentration of at least about 0.1 wt % as measured by XPS. In some embodiments, the substrate comprises two or more of silicon, manganese, titanium, vanadium, aluminum and nitrogen. In some embodiments, the substrate comprises three or more of silicon, manganese, titanium, vanadium, aluminum and nitrogen. In some embodiments, the substrate comprises four or more of silicon, manganese, titanium, vanadium, aluminum and nitrogen. In some embodiments, the substrate comprises five or more of silicon, manganese, titanium, vanadium, aluminum and nitrogen. In some embodiments, the substrate comprises silicon, manganese, titanium, vanadium, aluminum and nitrogen. In some embodiments, the second layer is diffusion bonded to the substrate. In some embodiments, the second layer is an outermost layer.

In another aspect, the present disclosure provides a method for forming a metal-containing part, comprising: (a) providing a substrate comprising carbon at a concentration of at least about 0.001 wt % as measured by x-ray photoelectron spectroscopy (XPS); (b) using a slurry to deposit a first layer comprising at least one metal adjacent to the substrate, which at least one metal is selected from chromium and nickel; and (c) subjecting the first layer and the substrate to annealing under conditions that are sufficient to generate a second layer from the first layer adjacent to the substrate, wherein the second layer comprises the carbon and the at least one metal as a metal carbide, thereby forming the metal-containing part comprising the second layer and the substrate, wherein the second layer comprises domains of the metal carbide and domains without the metal carbide.

In some embodiments, the at least one metal comprises chromium. In some embodiments, the at least one metal comprises nickel. In some embodiments, the at least one metal comprises chromium and nickel. In some embodiments, the slurry comprises an alloying agent, a metal halide activator and a solvent, and wherein the alloying agent comprises the metal. In some embodiments, the alloying agent comprises carbon. In some embodiments, the metal halide activator comprises a monovalent metal, a divalent metal or a trivalent metal. In some embodiments, the substrate comprises steel.

In some embodiments, the first layer has a pattern or morphology that facilitates formation of the metal carbide. In some embodiments, the slurry has a viscosity from about 1 centipoise (cP) to 200 cP at a shear rate of shear rate of 1000 s⁻¹. In some embodiments, a slurry has a viscosity from about 1 centipoise (cP) to 150 cP at a shear rate of shear rate of 1000 s⁻¹. In some embodiments, the second layer is an outermost layer. In some embodiments, the carbon is at a concentration of at least about 0.01 wt % as measured by XPS. In some embodiments, the carbon is at a concentration of at least about 0.1 wt % as measured by XPS.

In another aspect, the present disclosure provides a method for forming a metal layer adjacent to a substrate, comprising: (a) providing a substrate comprising carbon at a concentration of at least about 0.001 wt % as measured by x-ray photoelectron spectroscopy (XPS); (b) using a slurry to deposit a first layer comprising at least one metal adjacent to the substrate, wherein the slurry has a viscosity from about 1 centipoise (cP) to 200 cP at a shear rate of shear rate of 1000 s⁻¹; and (c) subjecting the first layer and the substrate to annealing under conditions that are sufficient to generate a second layer from the first layer adjacent to the substrate, wherein the second layer comprises the carbon and the at least one metal as a metal carbide, thereby forming the metal-containing part comprising the second layer and the substrate, wherein the second layer comprises domains of the metal carbide and domains without the metal carbide.

In some embodiments, the slurry comprises an alloying agent, a metal halide activator and a solvent, and wherein the alloying agent comprises the metal. In some embodiments, the alloying agent comprises carbon. In some embodiments, the metal halide activator comprises a monovalent metal, a divalent metal or a trivalent metal. In some embodiments, the substrate comprises steel. In some embodiments, the first layer has a pattern or morphology that facilitates formation of the metal carbide. In some embodiments, the slurry has a viscosity from about 1 centipoise (cP) to 150 cP at a shear rate of shear rate of 1000 s⁻¹. In some embodiments, the second layer is an outermost layer. In some embodiments, the carbon is at a concentration of at least about 0.01 wt % as measured by XPS. In some embodiments, the carbon is at a concentration of at least about 0.1 wt % as measured by XPS.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 illustrates a method for forming a layer adjacent to a substrate;

FIG. 2 shows change in viscosity as a result of varying shear rate for a slurry with varying amounts of water;

FIG. 3 shows change in viscosity as a result of varying shear rate for the slurry with varying amounts of water;

FIG. 4 shows change in viscosity as a result of varying amounts of water for the slurry;

FIG. 5 shows change in yield stress as a result of varying amounts of water for the slurry;

FIG. 6 is a table that shows the change in viscosity, shear thinning index, and yield stress as a result of varying amounts of water;

FIG. 7 shows change in viscosity as a result of varying shear rate for a slurry with varying amounts of chromium;

FIG. 8 is a table that shows change in viscosity, shear thinning index (10:1000 and 100:1000), and yield stress for a slurry as a result of varying amounts of chromium:

FIG. 9 shows change in viscosity as a result of varying amounts of chromium for a slurry;

FIG. 10 shows change in yield stress as a result of varying amounts of chromium for a slurry;

FIG. 11 shows a calculated and an experimental Krieger-Dougherty fit of chromium loading to viscosity for a slurry;

FIG. 12 is a table that shows change in viscosity, shear thinning index (10:1000 and 100:1000), and yield stress for a slurry as a result of varying amounts of aluminum (III) oxide;

FIG. 13 shows change in viscosity for a slurry as a result of varying amounts of aluminum (III) oxide;

FIG. 14 shows change in yield stress for a slurry as a result of varying amounts of aluminum (III) oxide;

FIG. 15 shows a calculated and an experimental Krieger-Dougherty fit of aluminum (III) oxide loading to viscosity for a slurry;

FIG. 16 is a table that shows change in viscosity, shear thinning index (10:1000 and 100:1000), and yield stress for a slurry as a result of varying amounts of magnesium chloride;

FIG. 17 shows change in viscosity as a result of varying amounts of magnesium chloride for a slurry;

FIG. 18 shows change in yield stress as a result of varying amounts of magnesium chloride for a slurry;

FIG. 19 shows change in fluidity with different chloride sources with varied chloride amounts for a slurry;

FIG. 20 shows change in pH with different chloride sources with varying amounts of chloride for a slurry;

FIG. 21 shows change in fluidity with varying concentrations of magnesium salts for a slurry;

FIG. 22 shows change in pH with various concentrations of magnesium salts for a slurry;

FIG. 23 shows change in yield stress with various concentrations and shear rates of magnesium acetate for a slurry;

FIG. 24 shows change in yield stress with various concentrations and shear rates of magnesium sulfate for a slurry;

FIG. 25 shows change in pH, viscosity, and yield stress with various magnesium salts across a range of concentrations of salts for a slurry;

FIG. 26 shows change in pH, viscosity, and yield stress with various salts across a range of concentrations of salts for a slurry;

FIG. 27 shows change in yield stress as result of various concentrations of ions for a slurry;

FIG. 28 shows a computer control system that is programmed or otherwise configured to implement methods provided herein;

FIG. 29 shows a slurry-coated substrate with a surface finish; and

FIG. 30A shows a cross section of a layer adjacent to a substrate after a slurry has been annealed adjacent to the substrate. Chromium carbide is present on the surface of the layer. FIG. 30B shows a cross section of a layer adjacent to a substrate after a slurry has been annealed adjacent to the substrate. Chromium carbide is not present on the surface of the layer.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “slurry,” as used herein, generally refers to a solution comprising a liquid phase and a solid phase. The solid phase may be in the liquid phase. A slurry may have one or more liquid phases and one or more solid phases.

The term “adjacent” or “adjacent to,” as used herein, generally refers to ‘next to’, ‘adjoining’, ‘in contact with,’ and ‘in proximity to.’ In some instances adjacent to may be ‘above’ or ‘below.’ A first layer adjacent to a second layer may be in direct contact with the second layer, or there may be one or more intervening layers between the first layer and the second layer.

The present disclosure provides slurry compositions (or slurries), as well as systems and methods that employ the slurries to form layers adjacent to substrates. Such layers can include, for example, one or more of iron, chromium, nickel, silicon, vanadium, titanium, boron, tungsten, aluminum, molybdenum, cobalt, manganese, zirconium, and niobium, oxides thereof, nitrides thereof, sulfides thereof, or combinations thereof.

The present disclosure provides slurries for use in forming layers adjacent to substrates. A slurry can include various components. The components of the slurry may include an alloying agent, an activator such as a halide activator, a solvent, and an inert species. The alloying agent may contain at least one elemental species that is configured to diffuse to or into a substrate. Diffusion of the elemental species to or into the substrate may be facilitated by the activator. The alloying agent may be dispersed in the solvent with the aid of the inert species. The inert species may have a particle size that is less than or equal to about 200 mesh.

The elemental species in the alloying agent can diffuse into or onto the substrate according to a concentration gradient. For example, the concentration of the elemental species in the alloying agent can be highest on the surface of the substrate and can decrease according to a gradient along the depth of the substrate. The decrease in concentration can be linear, parabolic, Gaussian, or any combination thereof. The concentration of the alloying agent in the slurry can be selected based on the desired thickness of the alloy layer to be formed on the substrate. The particle size of the alloying agent may be less than about 140 mesh.

The elemental species in the alloying agent can be at transition metal. The elemental species in the alloying agent can be chromium, nickel, aluminum, silicon, vanadium, titanium, boron, tungsten, molybdenum, cobalt, manganese, zirconium, niobium, or combinations thereof.

The alloying agent can comprise carbon. For some applications, the alloying agent contains low levels of carbon. The alloying agent can comprise a transition metal. The alloying agent can comprise iron, chromium, nickel, silicon, vanadium, titanium, boron, tungsten, aluminum, molybdenum, cobalt, manganese, zirconium, niobium, or combinations thereof. The alloying agent can be a ferroalloy of a transition metal. The alloying agent can be ferrosilicon (FeSi), ferro chromium (FeCr), chromium (Cr), or combinations thereof. The alloying agent can be a salt or an oxide. The alloying agent can comprise chromium, nickel, iron, or combinations thereof.

The diffusion of the elemental species in the alloying agent to the substrate can be facilitated by an activator. The activator may be a halide activator. The halide may transport the elemental species in the alloying agent to the surface of the substrate and thus facilitate diffusion of the elemental species to the substrate. For example, the alloying agent may comprise chrome and the halide activator may comprise a chloride. Chloride precursors may transport chrome to the surface of the substrate. The molar ratio of a halide of the halide activator to the elemental species may be at most about 0.0001:1, 0.001:1, 0.1:1, 0.5:1, 1:1, 2:1, 3:1, 4:1, 5:1, 6:1, 7:1, 8:1, 9:1, or 10:1. The molar ratio of a halide of the halide activator to the elemental species may be from about 0.0001:1 to 10:1, or 0.001:1 to 5:1. The molar ratio of a halide of the halide activator to the elemental species may be at most about 10:1.

The diffusion of the elemental species in the alloying agent to the substrate can be facilitated by an activator. The activator may be a metal halide activator. The metal halide may transport the elemental species in the alloying agent to the surface of the substrate and thus facilitate diffusion of the elemental species to the substrate. For example, the alloying agent may comprise chrome and the metal halide activator may comprise a chloride. Chloride precursors may transport chrome to the surface of the substrate. The molar ratio of a halide of the metal halide activator to the elemental species may be at most about 0.0001:1, 0.001:1, 0.1:1, 0.5:1, 1:1, 2:1, 3:1, 4:1, 5:1, 6:1, 7:1, 8:1, 9:1, or 10:1. The molar ratio of the halide of the metal halide activator to the elemental species may be from about 0.0001:1 to 10:1, or 0.001:1 to 5:1.

The activator may also impact the adhesion of the slurry of the substrate. In addition, the activator may impact the viscosity of the slurry. Further, the activator may influence the green strength of the slurry-coated substrate. Green strength generally refers to the ability of a slurry-coated substrate to withstand handling or machining before the slurry is completely cured. Accordingly, the activator may be selected based on the desired degree of adhesion of the slurry to the substrate, the desired viscosity of the slurry, and the ability of the activator to increase the green strength of the slurry-coated substrate. In addition, the activator may be selected based on corrosivity of the activator with respect to the substrate. For example, because some metal halides can be corrosive to metal substrates and because corrosion may be undesirable, those metal halides may not selected as activators. In addition, some metal halides can be corrosive to components of a roll coating assembly which applies the slurry to the substrate. Such corrosion may be undesirable. Thus, those metal halides may not be selected as activators. The activator may prevent the formation of Kirkendall voids at the boundary interface of the alloying agent and the substrate. Upon heating, a halide activator may decompose to an oxide. After annealing, the activator may act as a binder. In addition, after annealing, the activator may become inert. The concentration of activator can be variable. In some embodiments, the concentration of activator can be widely variable. The concentration of activator may depend on the amount of binders that are added to the slurry.

The activator may be a metal polymer. The activator may include a monovalent metal, a divalent metal, or a trivalent metal. The activator may be a di-metal halide. Examples of activators include magnesium chloride (MgCl₂), iron (II) chloride (FeCl₂), calcium chloride (CaCl₂), zirconium (IV) chloride (ZrCl₄), titanium (IV) chloride (TiCl₄), niobium (V) chloride (NbCl₅), titanium (III) chloride (TiCl₃), silicon tetrachloride (SiCl₄), vanadium (III) chloride (VCl₃), chromium (III) chloride (CrCl₃), trichlorosilance (SiHCl₃), manganese (II) chloride (MnCl₂), chromium (II) chloride (CrCl₂), cobalt (II) chloride (CoCl₂), copper (II) chloride (CuCl₂), nickel (II) chloride (NiCl₂), vanadium (II) chloride (VCl₂), ammonium chloride (NH₄Cl), sodium chloride (NaCl), potassium chloride (KCl), and combinations thereof.

In some cases, magnesium chloride may be a more desirable activator than iron chloride. Magnesium chloride may be cheaper in cost than iron chloride, while rendering a green strength similar to the green strength rendered by iron chloride. A slurry with magnesium chloride as the activator can exhibit an increase in viscosity. The increased viscosity of the slurry may not increase the thickness of the dried slurry coating.

The activator may be hydrated. Non-limiting examples of hydrated activators include iron chloride tetrahydrate (FeCl₂.4H₂O), iron chloride hexahydrate (FeCl₂.6H₂O), and magnesium chloride hexahydrate (MgCl₂.6H₂O). Magnesium chloride hexahydrate may be a more desirable hydrated activator than iron chloride tetrahydrate. Magnesium chloride hexahydrate may be cheaper in cost than iron chloride tetrahydrate. In addition, magnesium chloride hexahydrate may be less corrosive to the substrate than iron chloride tetrahydrate.

Salt additives may be used to obtain desired physical properties of the slurry. Salts may be monovalent or divalent salts. Non-limiting examples of salt additives include molybdenum (II) sulfide (MoS), manganese (II) sulfide (MnS), iron (II) sulfide (FeS), iron (II) sulfide (FeS₂), iron (III) sulfide (Fe₂S₃), chromium (III) sulfide (Cr₂S₃), copper (II) sulfide (CuS), nickel (II) sulfide (NiS), magnesium (II) sulfide (MgS), magnesium (II) acetate Mg(OAc)₂, and magnesium sulfate MgSO₄. magnesium chloride (MgCl₂), ammonium chloride (NH₄Cl), iron chloride (FeCl₂), calcium chloride (CaCl₂), sodium chloride (NaCl), sodium acetate (NaOAc), sodium carbonate (Na₂CO₃), lithium chloride (LiCl), lithium acetate (LiOAc), potassium chloride (KCl), ammonium acetate (NH₄OAc), aluminum acetate (Al(OAc)₃), basic aluminum acetate (Al(OH)(OAc)₂), dibasic aluminum acetate (Al(OH)₂(OAc)).

The slurry may comprise a solvent. Examples of solvents, which can be used alone or as a mixture of solvents, include protic solvents, aprotic solvents, polar solvents, and nonpolar solvents. Non-limiting examples of solvents include alcohols, such as water, methanol, ethanol, 1-propanol, and 2-propanol aliphatic and aromatic hydrocarbons, such as pentane, hexane, cyclohexane, methylcyclohexane, benzene, toluene and xylene, ethers, such as diethyl ether, diethylene glycol dimethyl ether, tetrahydrofuran and dioxane; halogenated hydrocarbons, such as methylene chloride, chloroform, 1,1,2,2-tetrachloroethane and chlorobenzene; esters and lactones, such as ethyl acetate, butyrolactone and valerolactone; acid amides and lactams, such as dimethylformamide, dimethylacetamide and N-methylpyrrolidone, and ketones, such as acetone, dibutyl ketone, methyl isobutyl ketone and methoxyacetone.

A slurry may comprise an inert material which aids in dispersing the alloying agent in the solvent. The inert material may be in addition to other components of the slurry. The inert material may aid in controlling the viscosity of the slurry. For example, the inert material may increase viscosity by promoting hydrogen bonding between the activator and the solvent. In addition, hydrogen bonds may form between the inert material and the activator. Further, the inert material may prevent the alloying agent from dropping out of suspension. Further, the inert material may prevent “stickers” form forming during the annealing process.

Examples of inert material include, without limitation, alumina (Al₂O₃), silica (SiO₂), titanium dioxide (TiO₂), magnesium oxide (MgO), calcium oxide (CaO), bentonite clay, monterey clay, Kaolin clay, philosilicate clay, other clays, and combinations thereof. The inert material may include non-stoichiometric variants of such material.

The boiling point (or boiling temperature) of the solvent may be less than or equal to about 200° C., 190° C., 180° C., 170° C., 160° C., 150° C., 140° C., 130° C., 120° C., 110° C., or 100° C.

Chromium particles may be larger in size than other particles in the slurry, and can suspended without high polymer additions.

An organic binder, such as methyl cellulose and polyethylene oxide (PEO), may be added to the slurry. An inorganic binder, such as sodium silicate, may be added to the slurry. Organic binders and inorganic binders may allow reduction of the amount of activator without sacrificing green strength and rheological properties.

The particle size of the inert material may be less than about 140 mesh. The particle size of the inert material may be less than or equal to about 200 mesh, 300 mesh, 400 mesh, 500 mesh, or 600 mesh. The particle size of the inert material may be less than or equal to about 200 mesh. The particle size may help facilitate removal of the inert material after annealing.

The properties of the slurry can be a function of one or more parameters used to form the slurry, maintain the slurry or apply the slurry. Such properties can include viscosity, shear thinning index, and yield stress. Such properties can include Reynolds number, viscosity, pH, and slurry component concentration. Parameters that can influence properties of the slurry can include water content, alloying agent identity and content, halide activator identity and content, and inert species identity and content, temperature, shear rate and time of mixing.

The present disclosure also provides methods for forming a slurry. The slurry can be formed by mixing various components of the slurry in a mixing chamber (or vessel). In some examples, the slurry is formed by mixing one or more solvents, one or more alloying agents, one or more halide activators and one or more inert species in the chamber. Such components may be mixed at the same time or sequentially. For example, a solvent is provided in the chamber and an alloying agent is subsequently added to the chamber.

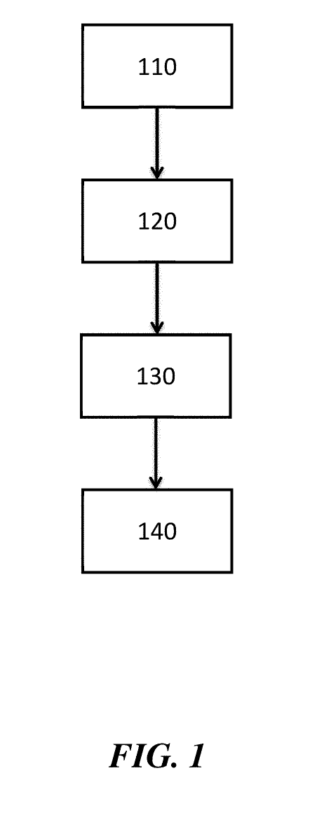

FIG. 1 illustrates a method of forming a layer adjacent to a substrate. In operation 110, a slurry is prepared from a combination of an alloying agent, activator, solvent, and inert species, as described elsewhere herein. Such components can be added to a mixing vessel sequentially or simultaneously. Next, in operation 120, the slurry can be applied from the mixing vessel to the substrate. In operation 130, the solvent in the slurry is removed after application by heat or vacuum drying at 90° C.-175° C. for 10-60 seconds. In operation 140, the web or substrate material is rolled or otherwise prepared for thermal treatment. The mixing sequence is that water is loaded first, the salts are added next, the alumina next, and finally the chromium is added.

During slurry production, the alloying agent, the activator, the solvent, and the inert species may be mixed together. To prevent clumping, dry ingredients may be added to the solvent in controlled amounts. The inert material and alloying agent may be in dry powder form.

The blade used to mix the slurry components may be in the shape of a whisk, a fork, or a paddle. More than one blade may be used to mix the slurry components. Each blade may have different shapes or the same shape. Dry ingredients may be added to the solvent in controlled amounts to prevent clumping. A high shear rate may be needed to help control viscosity.

The slurry may exhibit thixotropic behavior, wherein the slurry exhibits a decreased viscosity when subjected to sheer strain. The shear thinning index of the slurry can be from about 1 to about 8. In order to achieve the target viscosity, mixing may occur at a high shear rate. The shear rate can be from about 1 s⁻¹ to about 10,000 s⁻¹ (or Hz). The shear rate may be about 1 s⁻¹, about 10 s⁻¹, about 100 s⁻¹, about 1,000 s⁻¹, about 5,000 s⁻¹, or about 10,000 s⁻¹.

The shear rate of a slurry may be measured on various instruments. The shear rate may be measured on a TA Instruments DHR-2 rheometer, for example. The shear rate of a slurry may differ depending on the instrument used to perform the measurement.

In order to achieve the target or predetermined viscosity, mixing may occur for a period of time from 1 minute to 2 hours. The time of mixing may be less than 30 minutes. The viscosity of the slurry may decrease the longer the slurry is mixed. The time of mixing may correspond to the length of time needed to homogenize the slurry.

A properly mixed state may be a state where the slurry does not have water on the surface. A properly mixed state may be a state where there are no solids on the bottom of the vessel. The slurry may appear to be uniform in color and texture.

The desired viscosity of the slurry can be a viscosity that is suitable for roll coating. The viscosity of the slurry can be from about 1 centipoise (cP) to 5,000,000 cP. The viscosity of the slurry may be about 1 cP, about 5 cP, about 10 cP, about 50 cP, about 100 cP, about 200 cP, about 500 cP, about 1,000 cP, about 10,000 cP, about 100,000 cP, about 1,000,000 cP, or about 5,000,000 cP. The viscosity of the slurry may be at least about 1 cP, 5 cP, 10 cP, 50 cP, 100 cP, 200 cP, 500 cP, 1,000 cP, 10,000 cP, 100,000 cP, 1,000,000 cP, or 5,000,000 cP. The viscosity of the slurry may be from about 1 cP to 1,000,000 cP, or 100 centipoise cP to 100,000 cP. The viscosity of the slurry may depend on shear rate. The viscosity of the slurry may be from about 200 cP to about 10,000 cP, or about 600 cP to about 800 cP. The slurry may be from 100 cP to 200 cP in the application shear window that has shear rates from 1000 s⁻¹ to 1000000 s⁻¹. The capillary number of the slurry may be from about 0.01 to 10. The capillary number of the slurry may be at least about 0.01, 0.1, 0.5, 1, 2, 3, 4, 5, 6, 7, 8, 9, or 10. The yield stress of a slurry may be from about 0 to 1 Pa. The yield stress of the slurry may be at least about 0.01, 0.1, 0.2, 0.3, 0.4, 0.5, 0.6, 0.7, 0.8, 0.9, or 1.

The settling rate of the slurry may be stable to separation or sedimentation for greater than one minute, greater than 15 minutes, greater than 1 hour, greater than 1 day, greater than 1 month, or greater than 1 year. The settling rate of the slurry may refer to the amount of time the slurry is able to withstand, without mixing, before settling occurs, or before the viscosity increases to values that are not suitable for roll coating. Similarly, the shelf-life of the slurry may refer to the time that slurry can withstand, without mixing, before the slurry thickens to an extent unsuitable for roll coating. Even if the slurry settles and thickens, however, the slurry may be remixed to its initial viscosity. The thixotropic index of the slurry can be stable such that the slurry does not thicken to unsuitable levels at dead spots in the pan of a roll coating assembly.

The viscosity of the slurry can be controlled by controlling the extent of hydrogen bonding by adding acid to the slurry during mixing. In addition, acid or base may be added to the slurry during mixing in order to control the pH level of the slurry. The pH level of the slurry can be from about 3 to about 12. The pH level of the slurry can be about 5 to about 8. The pH level of the slurry can be about 3, about 4, about 5, about 6, about 7, about 8, about 9, about 10, about 11, or about 12. The pH level of the slurry may change as the slurry settles. Remixing the slurry after the slurry settles may return the pH level of the slurry to initial pH levels. Varying levels of binder, for example, metal acetate, may be added to a slurry to increase green strength in a slurry.

The fluidity of a slurry can be measured by a tilt test. A tilt test can be an indication of yield stress and viscosity. As an alternative, a rheometer may be used to measure the fluidity of the slurry.

The order in which the ingredients are added may be as follows: first, activator is added to solvent, then inert material is added; then, the alloying agent is added to the mixture. Acid can then be added to the mixture in order to control the pH level of the mixture. The method of addition may not be required to achieve acceptable slurry properties

The drying time of the slurry can be sufficiently long such that the slurry remains wet during the roll coating process and does not dry until after a coating of the slurry is applied to the substrate. The slurry may not dry at room temperature. The slurry may become dry to the touch after subjecting the drying zone of a roll coating line to heat for around ten seconds. The temperature of heat applied may be around 120° C.

The specific gravity of the slurry can be about 1 to 10 g/cm³. The green strength of the slurry can be such that the slurry is able to withstand roll coating such that the slurry coated substrate is not damaged. For example, a dry film of slurry, dried after roll-coating in the drying oven adjacent to the paint booth, may have a green strength that allows the film to survive a force that flexes the film, twenty times, in alternating negative and positive directions, to an arc with a diameter of 20 inches. The green strength of the dry film of slurry may further allow the film to pass a tape test with a small amount of powdering. The tape test may involve contacting a piece of tape with the surface of the coated material. The tape, once removed from the surface of the coated material, may be clear enough to allow one to see through any powder that had adhered to the tape.

After the slurry is prepared, it may be applied to a substrate through, for example, a roll coating process. The substrate may comprise metal such as iron, copper, aluminum, or any combination thereof. The substrate may comprise an alloy of metals. The alloy may include impurities. The substrate may comprise steel. The substrate may be a steel substrate. The substrate may comprise ceramic. The substrate may be devoid of free carbon. The substrate can be made from melt phase. The substrate may be in a cold reduced state, in a full hard state (e.g., not subjected to an annealing step after cold reduction), or in a hot rolled pickled state.

The surface of the substrate may be free of processing oxides. This may be achieved by conventional pickling. The surface of the substrate can be reasonably free of organic materials. The surface of the substrate may be reasonably free of organic materials after processing with commercially available cleaners.

Grain pinning particles may be added, removed, or withheld from the substrate during preparation of the substrate in order to control the grain size of the substrate. For example, grain pinners may be added to the substrate in order to keep the grain size small and to form pinning points. As another example, grain pinners may be withheld from the substrate to allow the grains to grow large and to allow for motor laminations. Grain pinners may be insoluble at the annealing temperatures.

Examples of grain pinning particles include an intermetallic, a nitride, a carbide, a carbonitride of titanium, aluminum, niobium, vanadium, and combinations thereof. Non-limiting examples of grain pinning particles include titanium nitride (TiN), titanium carbide (TiC), and aluminum nitride (AlN).

The slurry can be applied to the substrate by roll coating, split coating, spin coating, slot coating, curtain coating, slide coating, extrusion coating, painting, spray painting, electrostatic mechanisms, printing (e.g., 2-D printing, 3-D printing, screen printing, pattern printing), chemical vapor deposition, dipping, spraying, combinations thereof, or through any other suitable method.

The substrate may be pretreated before the slurry is applied to the substrate. The substrate may be pretreated by using chemicals to modify the surface of the substrate in order to improve adhesion of the slurry to the surface of the substrate. Examples of such chemicals include chromates and phosphates.

The slurry can be applied to the substrate by various approaches, such as roll coating. The roll coating process may begin by providing a substrate, such as a steel substrate. The substrate may be provided as a coil, mesh (e.g., coiled mesh), wire, pipe, tube, slab, mesh, dipped formed part, foil, plate, sheet (e.g., sheet with a thickness from 0.001 inches to 0.100 inches), wire rope, or a rod, or threaded rod where a screw pattern has been applied to any length or thickness of rod. Next, the coiled substrate may be unwound. Next, the unwound steel substrate may be provided to roll coaters, which may be coated with slurry. Next, the roll coaters may be activated such that the roll coaters coat the substrate with the slurry. The substrate may be fed through the roll coaters through multiple cycles such that the slurry is applied to the substrate multiple times. Depending on the properties of the slurry, it may be desirable to apply multiple coatings of the slurry to the substrate. Multiple coatings of the slurry can be applied to the substrate in order to achieve the desired thickness of the slurry. Different slurry formulations may be used in each of the multiple coatings. The slurry may be applied in a manner such as to form a pattern on the substrate. The pattern may in the form of, for example, a grid, stripes, dots, welding marks, or any combinations thereof. Multiple coatings on the same substrate may form a split coat on a substrate.

After the slurry is applied to the substrate, the solvent in the slurry may be removed by heating, vaporization, vacuuming, or any combination thereof. After the solvent is driven off, the substrate may be recoiled. Next, the coiled slurry coated substrate may be annealed.

The slurry coated, coiled substrate may be placed in a retort and subjected to a controlled atmosphere during heat treatment. Removal of water may be necessary. Pulling vacuum to force hydrogen between wraps may be necessary. The annealing process may be via tight coil or loose coil annealing. Annealing the slurry coated substrate can allow the elemental species in the slurry to diffuse into or through the substrate. Up to about 100% wt of the elemental species may diffuse into or through the substrate upon annealing. Certain process conditions may afford only 1-5% of the elemental species diffusing from the coating into the substrate. Diffusion of the elemental species to the substrate may be aided by an activator in the slurry. To prevent loss of the activator during annealing, hydrochloric acid may be added to the annealing gas. Minimizing the partial pressure of activator in the reactor at high temperatures may maintain a low deposition rate that is essential for minimizing or stopping the formation of Kirkendall pores. Adding too much of an acidic activator may also cause corrosion of the coating equipment or the substrate. The annealing process may be a continuous annealing process.

The slurry-coated substrate may be incubated or stored under vacuum or atmospheric conditions prior to annealing. This occurs prior to annealing and may be useful in removing residual contaminants from the coating, for example, solvent or binder leftover from the coating process. The incubation period may last from about 10 seconds to about 5 minutes or may be more than about 5 minutes. The incubation period may be the time between coating and annealing, and may be the length of time needed to transport the coated article to the heat treatment facility or equipment. For example, the incubation period may last for about 10 seconds, about 30 seconds, about 1 minute, about 2 minutes, about 3 minutes, about 4 minutes, or about 5 minutes. The incubation temperature may range from about 50° C. to about 300° C. For example, the incubation temperature may be more than about 50° C., about 75° C., about 100° C., about 125° C., about 150° C., about 175° C., about 200° C., about 225° C., about 250° C., about 275° C., or about 300° C. After incubating, and prior to annealing, the dry film of slurry on the substrate can be maintained under vacuum conditions. The coating may be dry to the touch immediately following the drying step after the roll-coating process. Absorbed water or other contaminants may be present with the coating anytime between roll coating and annealing.

The annealing temperature may be about 800° C., 900° C., 1000° C., 1100° C., 1200° C., or 1300° C. The heating temperature during annealing can be about 800° C. to about 1300° C., such as about 900° C. to about 1000° C. The annealing atmosphere may comprise hydrogen, nitrogen, argon. The annealing atmosphere can be a vacuum.

The total annealing time, including heating, can range from about 5 hours to about 200 hours. For example, the total annealing time can be more than about 5 hours, about 20 hours, about 40 hours, about 60 hours, about 80 hours, about 100 hours, about 120 hours, about 140 hours, about 160 hours, about 180 hours, or about 200 hours. The maximum temperature during the annealing process may be reached in about 1 hour to 100 hours. For example, the maximum temperature during the annealing process may be reached in about 1 hour, 10 hours, 20 hours, 30 hours, 40 hours, 50 hours, 60 hours, 70 hours, 80 hours, 90 hours, or 100 hours.

Large articles may have hot spots or cold spots during thermal treatment, where an article may be coated evenly but heated unevenly. Hot spots or cold spots may be denoted to control the diffusion of alloying element into the article as uniformly as possible.

A residue may remain on the substrate after the annealing process. The activator in the slurry may be consumed or removed (e.g., deposited on the walls of the retort), and the concentration of the alloying agent is reduced due to its diffusion onto and/or into the substrate. However, after annealing, other residue in the form of, e.g., a powder, may remain on the substrate. The residue may comprise the inert material from the slurry. This residue may be removed prior to further processing (e.g., temper rolling). The reaction can be purged with HCl gas to halt the reaction. The purging with HCl gas can allow for the formation of a flat profile.

After annealing, a layer may be formed on the substrate. The layer may have at least one elemental species. The layer may be an outer layer with at least one elemental species having a concentration that varies by less than about 20 wt. %, about 15 wt. %, about 10 wt. %, about 5 wt. %, about 4 wt. %, about 3 wt. %, about 2 wt. %, about 1 wt. %, or about 0.5 wt. % in the outer layer. The substrate may comprise a bonding layer adjacent the outer layer. The elemental species may have a concentration that decrease to less than about 1.0 wt % in the boding layer. The layer may comprise stainless steel. Stainless steel may include chromium and in some cases nickel. The substrate can be substantially free of Kirkendall voids after annealing. The layer can impart characteristics on the substrate which the substrate did not previously contain. For example, the layer may make the substrate harder, more wear resistant, more aesthetically pleasing, more electrically resistive, less electrically resistive, more thermally conductive, or less thermally conductive. In addition, the layer may cause the speed of sound in the substrate to be faster or slower.

The slurry-coated substrate, after annealing, may yield a layer that may have a certain appearance. Such appearance may be tailored for various applications or uses. The layer may have an appearance similar to stainless steel. The layer may have an appearance that is shiny, dull, or a combination thereof. The surface of the layer may have a certain finish, for example, a coarse finish, an abrasive finish, a brushed finish, a sheen finish, a satin finish, a matte finish, a metallic finish, a reflective finish, a mirror finish, a wood finish, a dull finish, or combinations thereof.

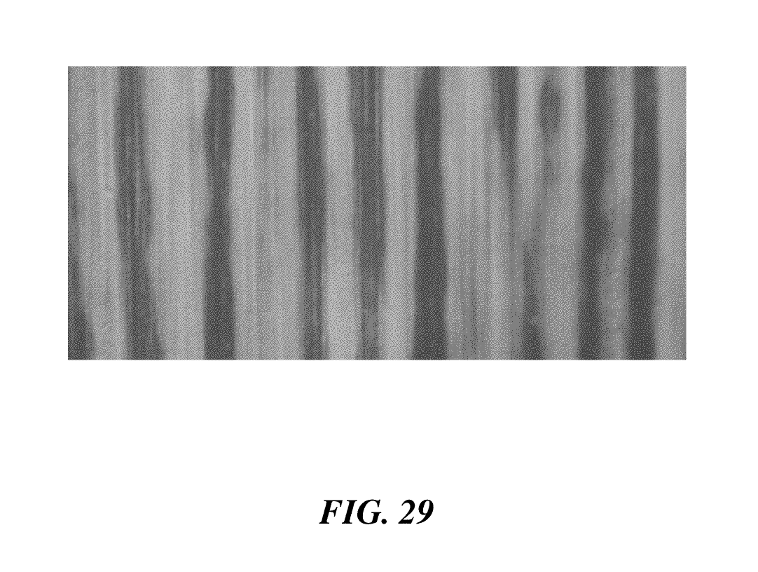

The surface of the layer may have, or appear to have, an aesthetically pleasing or desired appearance. FIG. 29 shows an example of a surface of a layer subsequent to subjecting a slurry-coated substrate to annealing. The layer has a surface finish that appears striated. The finish has light and dark bands. The light bands correspond to regions of chromium carbide and the dark bands correspond to regions of chromium without chromium carbide. The presence or absence of such bands may be selected based on the composition of the substrate adjacent to which the layer is formed. In some examples, the presence of such bands is dependent on the concentration of one or more elements (e.g., carbon) in such substrate.

The appearance of a layer may include, but is not limited to, a grainy texture, streaks, lines, various geometric shapes or combination of shapes, or a combination thereof. In some embodiments, the surface of a layer may have streaks. The streaks may be alternating between a dull finish and a shiny finish. The streaks may have short range or long range order. As an alternative, the streaks may not be ordered. In some examples, the streaks have dimensions of about 0.01 cm, 0.1 cm, 0.5 cm, 1 cm, 2 cm, 3 cm, 5 cm, or more.

A metal layer on a substrate may make the substrate harder. The layer may make the substrate about 10%, 20%, 30%, 40%, 50%, 60%, 70%, 80%, 90%, or more harder than an uncoated substrate. For some applications, the hardness of a coated substrate may be desired.

Different slurries may yield layers that exhibit different properties after coating on a substrate and annealing. For example, a particular formulation of slurry that is coated onto a substrate may yield a layer that makes a part having the layer and the substrate harder than another particular formulation of slurry that is coated onto the substrate. A particular formulation of slurry may make the part about 10%, 20%, 30%, 40%, 50%, 60%, 70%, 80%, 90%, or more harder than another particular formulation of slurry that is coated onto the substrate.

The present disclosure provides parts or objects (e.g., sheets, tubes or wires) coated with one or metal layers. A metal layer may include one or more metals. In some cases, a substrate may be coated with a metal layer. The coating may comprise an alloying agent having at least one elemental metal. A slurry-coated substrate may be formed when a substrate is coated with a slurry comprising an alloying agent having at least one elemental metal. The substrate that has been coated with an alloying agent may be subjected to annealing conditions to yield a layer adjacent to the substrate. The metal layer may be coupled to a substrate with the aid of a diffusion layer between the metal layer and the substrate.

The amount of an alloying agent in a diffusion layer may change with depth. The amount of an alloying agent in a diffusion layer may have a change with depth at a certain rate, such as about −0.01% per micrometer, about −0.01% per micrometer, about −0.01% per micrometer, about −0.05% per micrometer, about −0.1% per micrometer, about −0.5% per micrometer, about −1.0% per micrometer, about −3.0% per micrometer, about −5.0% per micrometer, about −7.0% per micrometer, or about −9.0% per micrometer. The amount of an alloying agent in a diffusion layer may have a change with depth from about −0.01% per micrometer to −5.0% per micrometer, or from about −0.01% per micrometer to −3.0% per micrometer. X-ray photoelectron spectroscopy (XPS) may be used to measure such change in amount (or concentration) with depth.

An alloying agent may have a concentration of at least about 5 wt % at a depth of less than or equal to 100 micrometers, about 10 wt % at a depth of less than or equal to 30 micrometers, about 15 wt % at a depth of less than or equal to 50 micrometers, or about 15 wt % at a depth of less than or equal to 10 micrometers from the surface of the substrate.

A concentration of an alloying agent in a metal layer may be at most about 20 wt. % over a depth of about greater than 100 micrometers, 15 wt. % over a depth of about greater than 110 micrometers, about 10 wt. % over a depth of about 125 micrometers, 8 wt. % over a depth of about greater than 140 micrometers, or about 6 wt. % over a depth of about 150 micrometers from the surface of the substrate.

A concentration of an alloying agent in a metal layer may decrease over a certain depth as a result of annealing of a metal layer on a substrate. A concentration of an alloying agent in a metal layer may decrease by no more than about 50 wt. % over a depth of about 100 micrometers, about 40 wt. % over a depth of about 90 micrometers, about 30 wt. % over a depth of about 70 micrometers, about 25 wt. % over a depth of about 60 micrometers, or about 20 wt. % over a depth of about 50 micrometers.

A metal layer that is coated onto a substrate may have a certain thickness after the metal layer is annealed onto the substrate. A metal layer that is coated onto a substrate may have a thickness less than about 1 millimeter, 900 micrometers, 800 micrometers, 700 micrometers, 600 micrometers, 500 micrometers, 400 micrometers, 300 micrometers, 200 micrometers, 100 micrometers, 10 micrometers, 5 micrometers, 1 micrometer, 500 nanometers (nm), 400 nanometers, 300 nanometers, 200 nanometers, 100 nanometers, 10 nanometers, or less. A metal layer that is coated onto a substrate may have a thickness of at least about 1 nanometer, 10 nanometers, 100 nanometers, 200 nanometers, 300 nanometers, 400 nanometers, 500 nanometers, 1 micrometer, 5 micrometers, 10 micrometers, 20 micrometers, 30 micrometers, 40 micrometers, 50 micrometers, 100 micrometers, 200 micrometers, 300 micrometers, 400 micrometers, 500 micrometers, 600 micrometers, 700 micrometers, 800 micrometers, 900 micrometers, 1000 micrometers, or more. In some examples, the thickness is from 10 nm to 100 micrometers, or 100 nm to 10 micrometers.

In some cases, the substrate may comprise greater than or equal to about 0.0001 wt %, 0.0005 wt %, 0.001 wt %, 0.002 wt %, 0.003 wt %, 0.004 wt %, 0.005 wt %, 0.01 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.5 wt %, 3 wt %, 5 wt %, 7 wt %, 10 wt %, 15 wt %, 20 wt %, 30 wt %, or 40 wt % carbon. In some cases, the substrate may comprise at least about 0.001 wt %, 0.002 wt %, 0.003 wt %, 0.004 wt %, 0.005 wt %, 0.01 wt %, 0.05 wt %, or 0.1 wt % carbon. In an example, a substrate comprises greater than or equal to about 0.004 wt % carbon.

In some cases, the substrate may comprise at most about 40 wt %, 30 wt %, 20 wt %, 10 wt %, 5 wt %, 4 wt %, 3 wt %, 2 wt %, 1 wt %, 0.5 wt %, or 0.1 wt % carbon.

In some cases, during annealing, the carbon from the substrate may migrate to the surface of the layer and precipitate as a metal carbide, such as, for example, chromium carbide. A resulting layer of the metal carbide (e.g., chromium carbide) may form on the surface of a layer. The metal in such metal carbide may include metal present in the substrate or a layer adjacent to the substrate.

In some cases, a substrate will comprise domains of a metal carbide. In some cases, a substrate will comprise domains without a metal carbide. In some cases, a substrate will comprise domains of chromium carbide. In some cases, a substrate will comprise domains without a chromium carbide.

In some cases, metal carbide may be present in a substrate or a layer of the substrate at a concentration of at least about 0.0001 wt %, 0.0005 wt %, 0.001 wt %, 0.002 wt %, 0.003 wt %, 0.004 wt %, 0.005 wt %, 0.01 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.5 wt %, 3 wt %, 5 wt %, 7 wt %, 10 wt %, 15 wt %, 20 wt %, 30 wt %, or 40 wt %.

In some cases, metal carbide may be present in the substrate or a layer of the substrate at a concentration of at most 40 wt %, 30 wt %, 20 wt %, 10 wt %, 9 wt %, 8 wt %, 7 wt %, 6 wt %, 5 wt %, 4 wt %, 3 wt %, 2 wt %, 1 wt %, 0.9 wt %, 0.8 wt %, 0.7 wt %, 0.6 wt %, 0.5 wt %, 0.4 wt %, 0.3 wt %, 0.2 wt %, 0.1 wt %, 0.05 wt %, 0.01 wt %, 0.005 wt %, 0.004 wt %, 0.003 wt %, 0.002 wt %, or 0.001 wt %.

In some cases, chromium carbide may be present in the substrate or a layer of the substrate at a concentration of at least about 0.0001 wt %, 0.0005 wt %, 0.001 wt %, 0.002 wt %, 0.003 wt %, 0.004 wt %, 0.005 wt %, 0.01 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.5 wt %, 3 wt %, 5 wt %, 7 wt %, 10 wt %, 15 wt %, 20 wt %, 30 wt %, or 40 wt %.

In some cases, chromium carbide may be present in the substrate or a layer of the substrate at a concentration of at most 40 wt %, 30 wt %, 20 wt %, 10 wt %, 9 wt %, 8 wt %, 7 wt %, 6 wt %, 5 wt %, 4 wt %, 3 wt %, 2 wt %, 1 wt %, 0.9 wt %, 0.8 wt %, 0.7 wt %, 0.6 wt %, 0.5 wt %, 0.4 wt %, 0.3 wt %, 0.2 wt %, 0.1 wt %, 0.05 wt %, 0.01 wt %, 0.005 wt %, 0.004 wt %, 0.003 wt %, 0.002 wt %, or 0.001 wt %.

In some cases, the concentration of free carbon in the substrate or a layer of the substrate may be at least about 0.0001 wt %, 0.0005 wt %, 0.001 wt %, 0.002 wt %, 0.003 wt %, 0.004 wt %, 0.005 wt %, 0.01 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.5 wt %, 3 wt %, 5 wt %, 7 wt %, 10 wt %, 15 wt %, 20 wt %, 30 wt %, or 40 wt %.

In some cases, the concentration of free carbon in the substrate or a layer of the substrate may be at most about 40 wt %, 30 wt %, 20 wt %, 10 wt %, 9 wt %, 8 wt %, 7 wt %, 6 wt %, 5 wt %, 4 wt %, 3 wt %, 2 wt %, 1 wt %, 0.9 wt %, 0.8 wt %, 0.7 wt %, 0.6 wt %, 0.5 wt %, 0.4 wt %, 0.3 wt %, 0.2 wt %, 0.1 wt %, 0.05 wt %, 0.01 wt %, 0.005 wt %, 0.004 wt %, 0.003 wt %, 0.002 wt %, or 0.001 wt %.

The appearance of the surface of the layer may depend on the quantity of certain elements in the substrate. The appearance of the surface of the layer may alter based on the formation of metal carbide (e.g., chromium carbide) on the surface of the layer. The formation of a metal carbide (e.g. chromium carbide) on the surface of the layer may depend on the concentration of free carbon in a substrate. In some examples, when the concentration of free carbon in the substrate is greater than or equal to about 0.0001 wt %, 0.0005 wt %, 0.001 wt %, 0.002 wt %, 0.003 wt %, 0.004 wt %, 0.005 wt % carbon, metal carbide (e.g., chromium carbide) may form on the surface of the layer. For example, if the concentration of free carbon is greater than or equal to about 0.004 wt % carbon, metal carbide (e.g., chromium carbide) forms on the surface of the layer. Free carbon may have the ability to migrate during annealing, such as migrate to a surface of the substrate or a layer adjacent to the substrate.

The formation of a metal carbide (e.g. chromium carbide) adjacent to the surface of the layer may depend on slurry coating morphology or the pattern in which the slurry is applied adjacent to the substrate. The slurry may be applied in a manner so as to form a pattern adjacent to the substrate. The pattern may be in the form of, for example, a grid, stripes, dots, welding marks, or any combination thereof. In an example, the slurry is applied adjacent to the substrate in a striped pattern, and the chromium carbide formed on the surface of the substrate after annealing has the striped pattern. The pattern may be selected to yield the layer having the metal carbide in a desired or otherwise predetermined pattern.

Metal carbide (e.g., chromium carbide) on the surface of a layer may have a different appearance than the surface of a layer without chromium carbide. Metal carbide (e.g., chromium carbide) on the surface of a layer may be lighter in color than the surface of a layer without chromium carbide. Metal carbide (e.g., chromium carbide) may be formed in a particular in a particular pattern on the surface of the layer, such as to achieve particular or desired pattern. The surface may have domains of metal carbide and domains without metal carbide. To facilitate formation of metal carbide (e.g., chromium carbide) on the surface of the layer, additional carbon may be deposited onto the substrate. The additional carbon may be co-deposited before, during, or after the slurry is coated adjacent to the substrate, and/or before, during or after annealing.

If sufficient carbon is present in the substrate, the slurry, or both, a layer of metal carbide (e.g., chromium carbide) may form on the entire surface of the metal layer adjacent to the substrate.

In some cases, free carbon is not available to precipitate as metal carbide (e.g., chromium carbide) on the surface of the layer. For example, carbon can be in the form of titanium carbon, which may not be available to precipitate as a metal carbide.

The substrate may comprise other elements. The substrate may comprise greater than or equal to about 0.0001 wt %, 0.0005 wt %, 0.001 wt %, 0.002 wt %, 0.003 wt %, 0.004 wt %, 0.005 wt %, 0.01 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.5 wt %, 3 wt %, 5 wt %, 7 wt %, 10 wt %, 15 wt %, 20 wt %, 30 wt %, or 40 wt % silicon. The substrate may comprise greater than or equal to about 0.0001 wt %, 0.0005 wt %, 0.001 wt %, 0.002 wt %, 0.003 wt %, 0.004 wt %, 0.005 wt %, 0.01 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.5 wt %, 3 wt %, 5 wt %, 7 wt %, 10 wt %, 15 wt %, 20 wt %, 30 wt %, or 40 wt % manganese. The substrate may comprise greater than or equal to about 0.0001 wt %, 0.0005 wt %, 0.001 wt %, 0.002 wt %, 0.003 wt %, 0.004 wt %, 0.005 wt %, 0.01 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.5 wt %, 3 wt %, 5 wt %, 7 wt %, 10 wt %, 15 wt %, 20 wt %, 30 wt %, or 40 wt % titanium. The substrate may comprise greater than or equal to about 0.0001 wt %, 0.0005 wt %, 0.001 wt %, 0.002 wt %, 0.003 wt %, 0.004 wt %, 0.005 wt %, 0.01 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.5 wt %, 3 wt %, 5 wt %, 7 wt %, 10 wt %, 15 wt %, 20 wt %, 30 wt %, or 40 wt % vanadium. The substrate may comprise greater than or equal to about 0.0001 wt %, 0.0005 wt %, 0.001 wt %, 0.002 wt %, 0.003 wt %, 0.004 wt %, 0.005 wt %, 0.01 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.5 wt %, 3 wt %, 5 wt %, 7 wt %, 10 wt %, 15 wt %, 20 wt %, 30 wt %, or 40 wt % aluminum. The substrate may comprise greater than or equal to about 0.0001 wt %, 0.0005 wt %, 0.001 wt %, 0.002 wt %, 0.003 wt %, 0.004 wt %, 0.005 wt %, 0.01 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.5 wt %, 3 wt %, 5 wt %, 7 wt %, 10 wt %, 15 wt %, 20 wt %, 30 wt %, or 40 wt % nitrogen.

Other properties of substrates coated with metal layers may be as described in, for example, U.S. Patent Publication No. 2013/0171471; U.S. Patent Publication No. 2013/0309410; U.S. Patent Publication No. 2013/0252022; U.S. Patent Publication No. 2015/0167131; and U.S. Patent Publication No. 2015/0345041, each of which is incorporated herein by reference in its entirety.

Another aspect of the present disclosure is a method for forming a metal-containing object comprising a metal layer adjacent to a substrate. The metal-containing object may be devoid of a material discontinuity between an outer layer of the metal-containing object and the substrate.

### Computer Control Systems

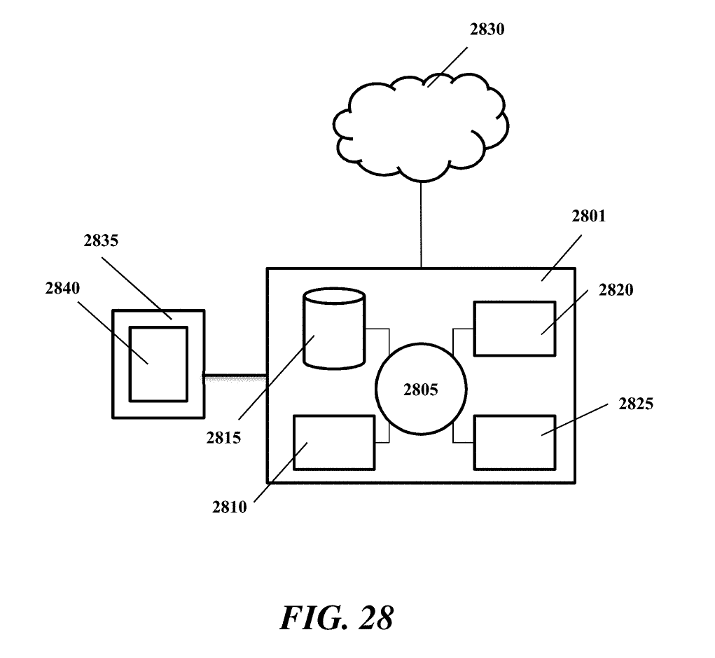

The present disclosure provides computer control systems that are programmed to implement methods of the disclosure. FIG. 28 shows a computer control system 2801 that is programmed or otherwise configured to produce the slurry and/or apply a coating of the slurry to a substrate. The computer control system 2801 can regulate various aspects of the methods of the present disclosure, such as, for example, methods of producing the slurry and methods of applying a coating of the slurry to the substrate. The computer control system 2801 can be implemented on an electronic device of a user or a computer system that is remotely located with respect to the electronic device. The electronic device can be a mobile electronic device.

The computer system 2801 includes a central processing unit (CPU, also “processor” and “computer processor” herein) 2805, which can be a single core or multi core processor, or a plurality of processors for parallel processing. The computer control system 2801 also includes memory or memory location 2810 (e.g., random-access memory, read-only memory, flash memory), electronic storage unit 2815 (e.g., hard disk), communication interface 2820 (e.g., network adapter) for communicating with one or more other systems, and peripheral devices 2825, such as cache, other memory, data storage and/or electronic display adapters. The memory 2810, storage unit 2815, interface 2820 and peripheral devices 2825 are in communication with the CPU 2805 through a communication bus (solid lines), such as a motherboard. The storage unit 2815 can be a data storage unit (or data repository) for storing data. The computer control system 2801 can be operatively coupled to a computer network (“network”) 2830 with the aid of the communication interface 2820. The network 2830 can be the Internet, an internet and/or extranet, or an intranet and/or extranet that is in communication with the Internet. The network 2830 in some cases is a telecommunication and/or data network. The network 2830 can include one or more computer servers, which can enable distributed computing, such as cloud computing. The network 2830, in some cases with the aid of the computer system 2801, can implement a peer-to-peer network, which may enable devices coupled to the computer system 2801 to behave as a client or a server.

The CPU 2805 can execute a sequence of machine-readable instructions, which can be embodied in a program or software. The instructions may be stored in a memory location, such as the memory 2810. The instructions can be directed to the CPU 2805, which can subsequently program or otherwise configure the CPU 2805 to implement methods of the present disclosure. Examples of operations performed by the CPU 2805 can include fetch, decode, execute, and writeback.

The CPU 2805 can be part of a circuit, such as an integrated circuit. One or more other components of the system 2801 can be included in the circuit. In some cases, the circuit is an application specific integrated circuit (ASIC).

The storage unit 2815 can store files, such as drivers, libraries and saved programs. The storage unit 2815 can store user data, e.g., user preferences and user programs. The computer system 2801 in some cases can include one or more additional data storage units that are external to the computer system 2801, such as located on a remote server that is in communication with the computer system 2801 through an intranet or the Internet.

The computer system 2801 can communicate with one or more remote computer systems through the network 2830. For instance, the computer system 2801 can communicate with a remote computer system of a user (e.g., a user controlling the manufacture of a slurry coated substrate). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 2801 via the network 2830.

Methods as described herein can be implemented by way of machine (e.g., computer processor) executable code stored on an electronic storage location of the computer system 2801, such as, for example, on the memory 2810 or electronic storage unit 2815. The machine executable or machine readable code can be provided in the form of software. During use, the code can be executed by the processor 2805. In some cases, the code can be retrieved from the storage unit 2815 and stored on the memory 2810 for ready access by the processor 2805. In some situations, the electronic storage unit 2815 can be precluded, and machine-executable instructions are stored on memory 2810.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 2801, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 2801 can include or be in communication with an electronic display 2835 that comprises a user interface (UI) 2840 for providing, for example, parameters for producing the slurry and/or applying the slurry to a substrate. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 2805. The algorithm can, for example, regulate the mixing shear rate of the slurry, the amount of each ingredient added to the slurry mixture, and the order in which the ingredients are added to the slurry mixture. As another example, the algorithm can regulate the speed at which the slurry is applied to the substrate and the number of coatings of slurry applied to the substrate.

### EXAMPLES

### Example 1

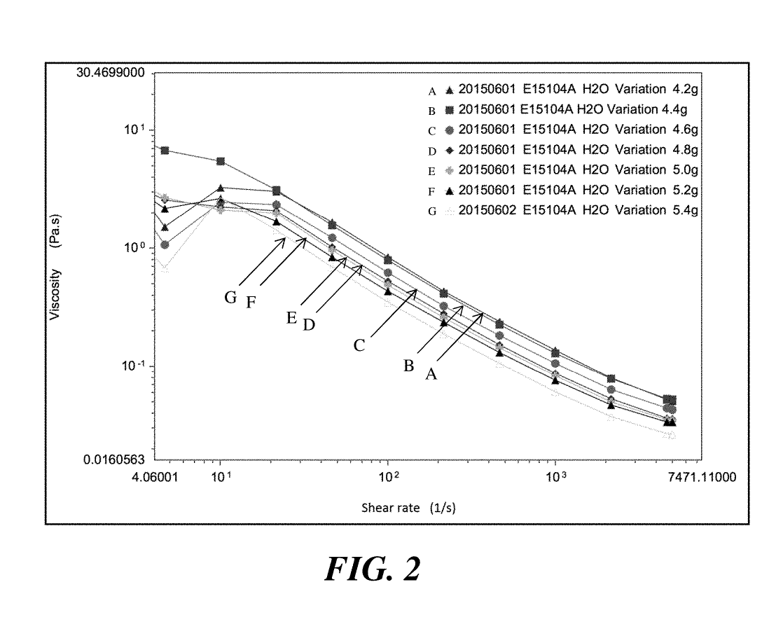

In an example, a slurry is formed by mixing water, an alloying agent, a halide activator and an inert species in a mixing chamber, with species of chromium, magnesium chloride hexahydrate, and alumina. These components are added to the mixing chamber while mixing a resulting solution. The shear rate of mixing can be varied, and properties such as viscosity and yield stress are recorded, listed, and shown in FIG. 2-FIG. 6.

The amount of water added to the slurry is varied to form a number of slurries, and the resulting effect on properties of the slurries is recorded. Next, the slurry is applied to a carbon steel substrate via a roll coating process. The slurry is then annealed at 200° C. for 2 hours. The slurry is then dried to completeness from about 2 hours to about 100 hours or longer. The atmosphere near the chromized article's surface may be below −20° F. dew point.

### Example 2

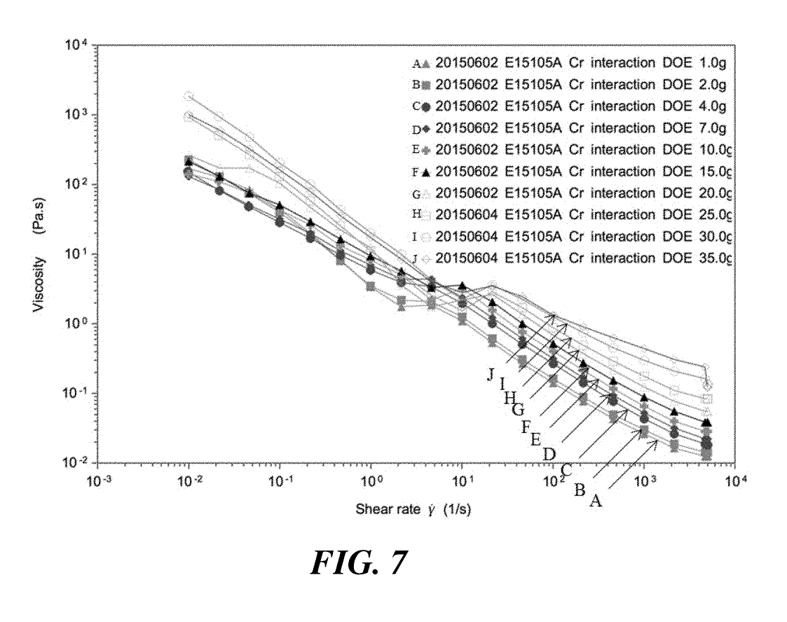

In another example, a slurry is formed by mixing various components of the slurry in a mixing chamber. The slurry is formed by mixing a solvent, such as water, an alloying agent, such as iron silicate, a halide activator, such as iron chloride, and an inert species, such as chromium, in a high shear mixer. Shear rate is varied, and properties such as viscosity and yield stress are recorded and listed in FIG. 7-FIG. 10. The amount of chromium added to the slurry is varied to form a number of slurries, and the resulting effect on properties of the slurries is recorded. The slurry is then applied to a substrate roll coating. The slurry is dried on the substrate that brings the substrate to a temperature from 70° C. to 120° C. for a time from 20 seconds and 120 seconds. The excess slurry is removed before subsequent processing.

### Example 3

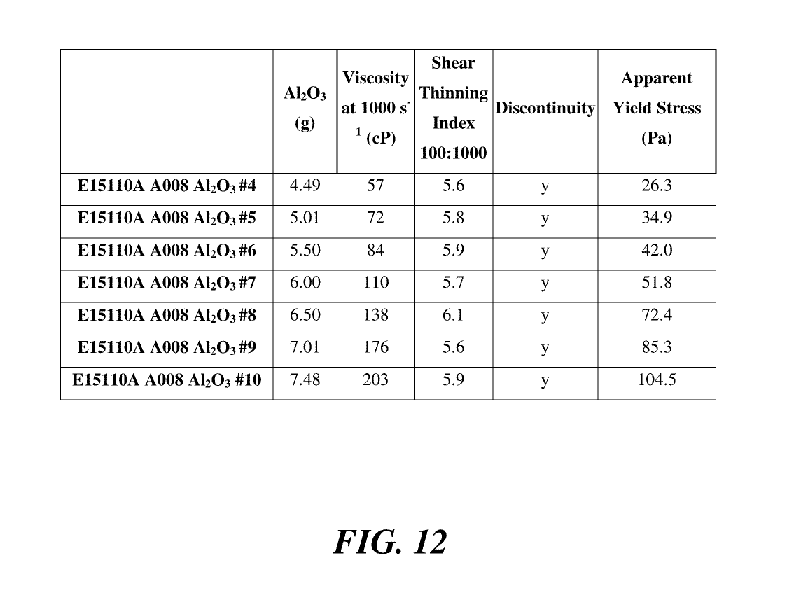

In another example, a slurry is formed by mixing various components of the slurry in a mixing chamber. The slurry is formed by mixing a solvent, such as water, an alloying agent, such as iron silicate, a halide activator, such as iron chloride, and an inert species, such as aluminum (III) oxide, in a chamber. Shear rate is varied, and properties such as viscosity and yield stress are recorded and listed in FIG. 12-FIG. 14. The amount of alumina added to the slurry is varied to form a number of slurries, and the resulting effect on properties of the slurries is recorded. The slurry is then applied to a substrate via a single step process. The slurry is dried on the substrate that brings the substrate to a temperature from 70° C. to 120° C. for a time from 20 seconds and 120 seconds. The excess slurry is removed before subsequent processing.

### Example 4

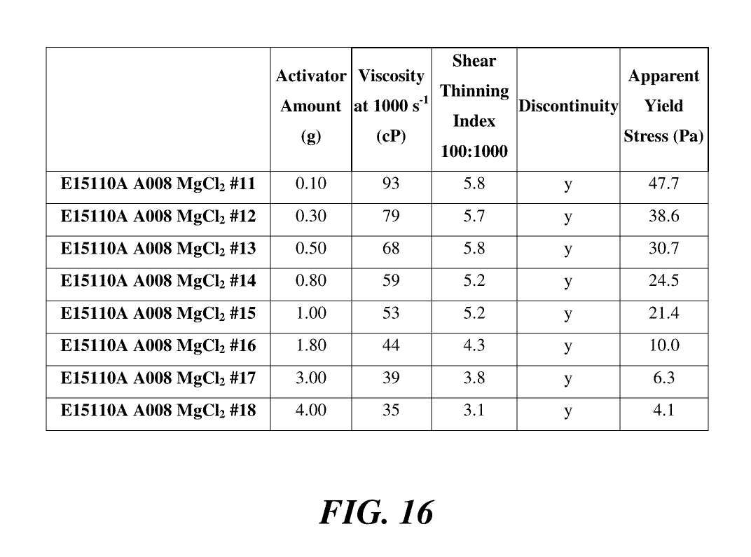

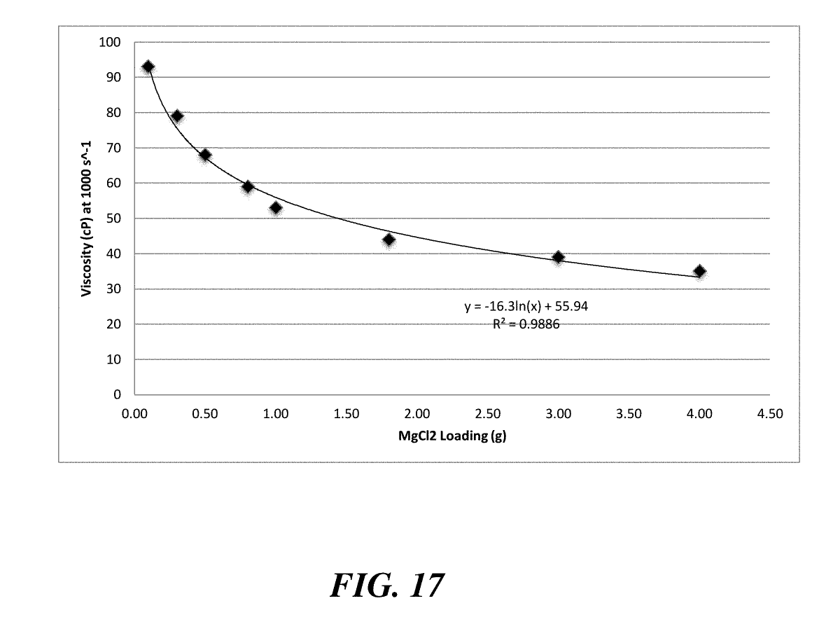

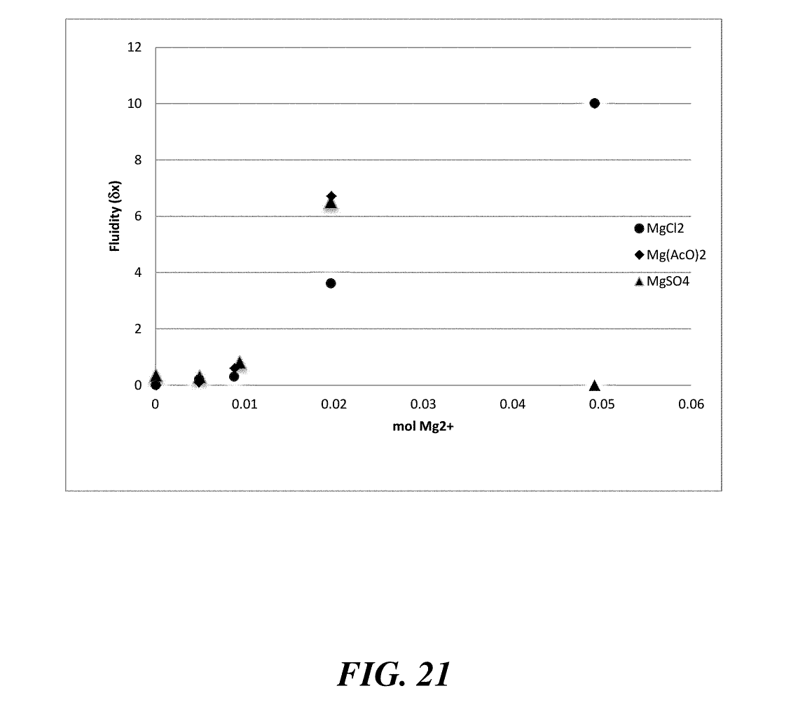

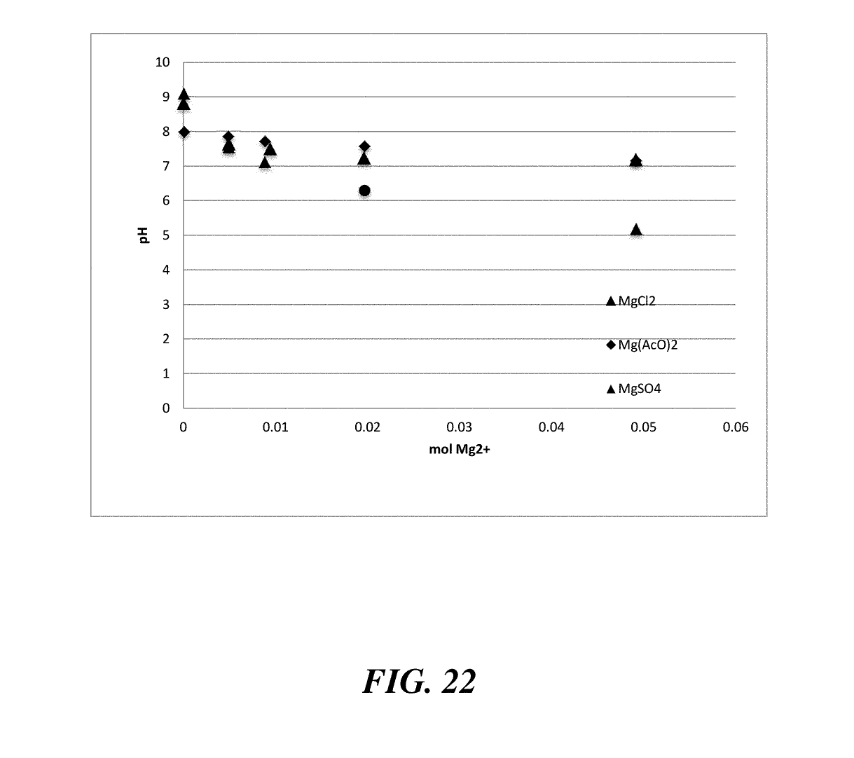

In another example, a slurry is formed by mixing various components of the slurry in a mixing chamber. The slurry is formed by mixing a solvent, such as water, an alloying agent, such as ferro-silicon, a halide activator, such as iron chloride, and an inert species, such as alumina, in a chamber. Shear rate is varied, and properties such as viscosity, yield stress, fluidity, and pH are recorded and listed in FIG. 16-FIG. 18, FIG. 21 and FIG. 22. The amount of magnesium chloride added to the slurry is varied to form a number of slurries, and the resulting effect on properties of the slurries is recorded.

### Example 5

In another example, a slurry is formed, comprising 15 g chromium, 5.25 g alumina, 0.25 g MgCl₂.6H₂O, and water in amounts from 4.2 g to 5.4 g in 0.2 g increments. These components are added to the mixing chamber while mixing a resulting solution. The shear rate of mixing can be varied, and properties such as viscosity and yield stress are recorded, listed, and shown in FIG. 2-FIG. 6.

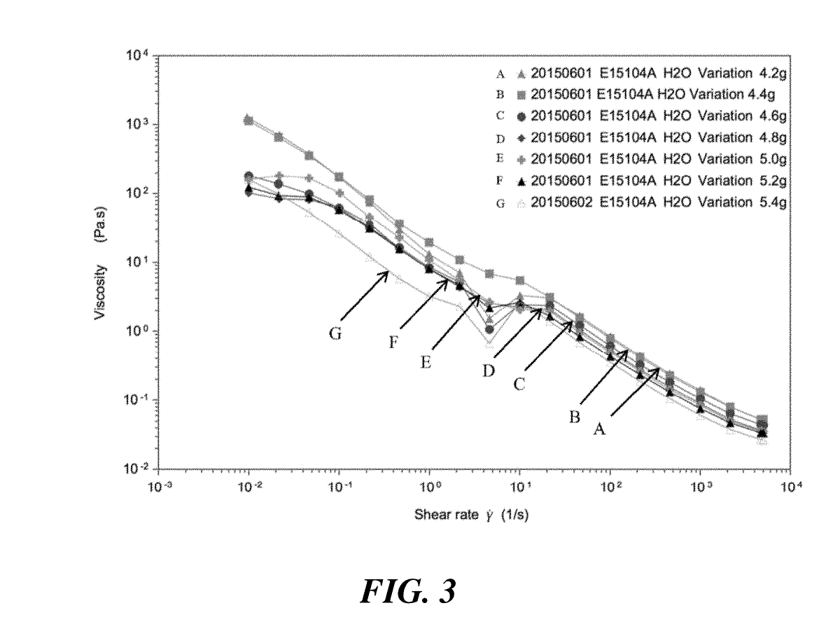

FIGS. 2 and 3 illustrate examples in which varying amounts of water can affect the viscosity of a slurry. The figures show various curves A-G in which viscosity may decrease with increasing shear rate. The curves are in order of increasing water content. For example, curve A has a water content of 4.2 grams (g) and curve G has a water content of 5.4 g. Generally, increasing the shear rate can decrease the viscosity of the slurry. Increasing the amount of water can decrease the viscosity of the slurry. In some cases, the slurry can have a viscosity from about 1×10⁻² pascal (Pa) second to 100 Pa second at a shear rate from about 0.01 s⁻¹ to 1,000 s⁻¹. For example, the slurry can have a viscosity of 10 Pa second at 4 s⁻¹ or 1×10⁻² Pa second at 7400 s⁻¹.

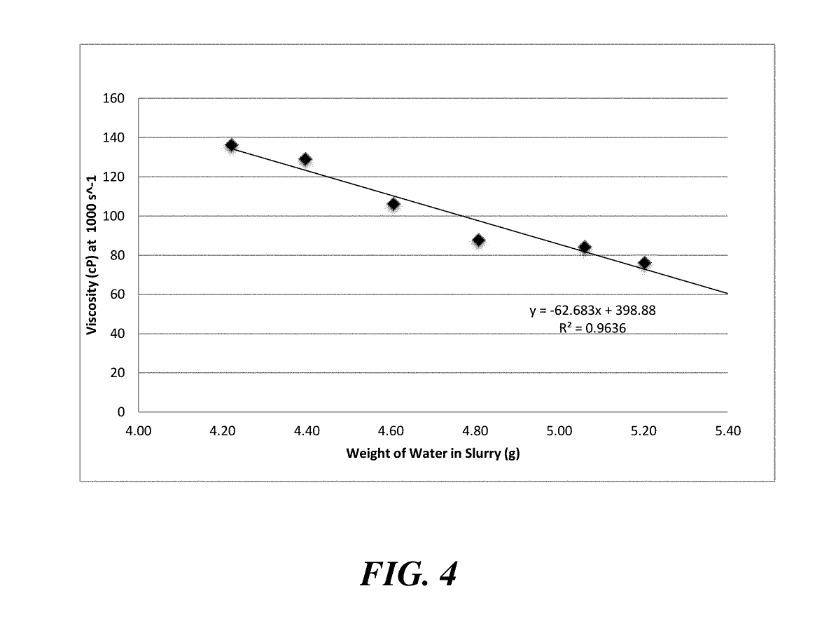

The viscosity of the slurry can be a function of the weight of water in the slurry. FIG. 4 illustrates change in viscosity at a fixed shear rate (1000 s⁻¹) as a result of varying amounts of water of a slurry. An increase of weight of water in the slurry can decrease the viscosity of the slurry. The decrease may be linear. In some examples, the viscosity of the slurry at a shear rate of 1000 s⁻¹ can be from about 140 centipoise (cP) at a weight of water in the slurry of about 4.2 g to 60 cP at a water weight of 5.4 g.

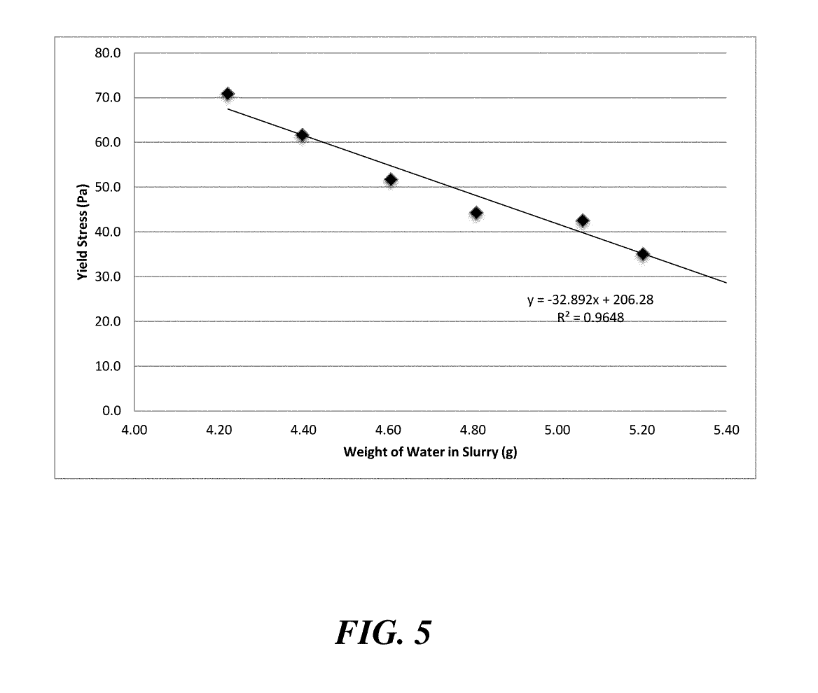

The yield stress of the slurry can be a function of the weight of water in the slurry. FIG. 5 illustrates change in yield stress as a result of varying amounts of water of a slurry. An increase of weight of water in the slurry can decrease the yield stress of the slurry. The decrease may be linear. In some examples, the yield stress of the slurry can be about 70 pascal (Pa) at a weight of water in the slurry of about 4.2 g to about 30 Pa at a water weight of 5.4 g.

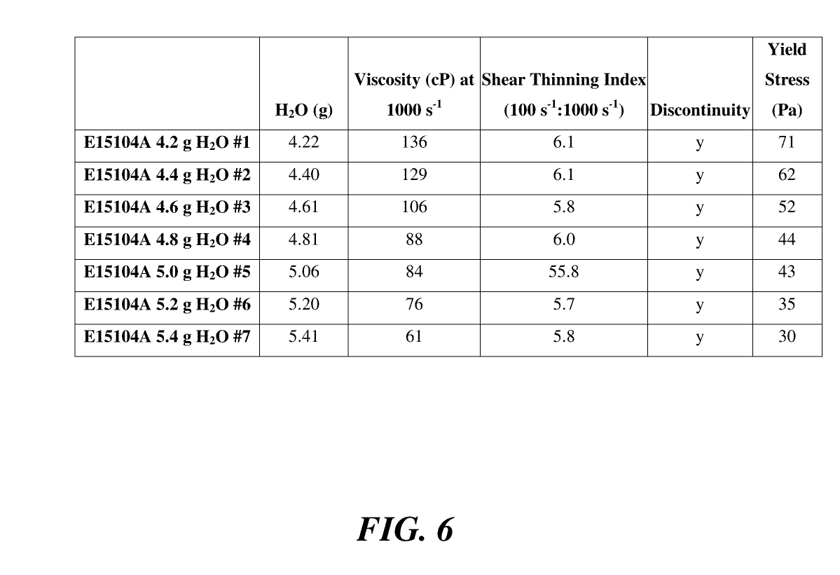

FIG. 6 illustrates change in viscosity, shear thinning index, and yield stress as a result of varying amounts of water. Generally, increasing the amount of water in the slurry can decrease the viscosity of the slurry. The decrease may be linear. In some examples, the viscosity of the slurry at a shear rate of 1000 s⁻¹ can be from about 136 centipoise (cP) at a weight of water in the slurry of about 4.2 g to 61 cP at a water weight of 5.4 g. Generally, increasing the amount of water in a slurry can decrease the shear thinning index of the slurry. The decrease may be linear. In some examples, the shear thinning index can be from about 6.1 (100:1000 s⁻¹) at a weight of water in the slurry of about 4.2 g to about 5.8 at a water weight of 5.4 g. An increase of weight of water in a slurry can decrease the yield stress of the slurry. The decrease may be linear. In some examples, the yield stress of the slurry can be about 71 pascal (Pa) at a weight of water in the slurry of about 4.2 g to about 30 Pa at a water weight of 5.4 g.

### Example 6

The viscosity of a slurry can be a function of the weight of an alloying agent in the slurry, such as chromium. FIG. 7 illustrates an example in which varying amounts of chromium can affect the viscosity of a slurry. A slurry is formed, comprising 5 g water, 5.25 g alumina, 0.25 g MgCl₂.6H₂O, and chromium in amounts from 1 g to 35 g. The figure shows various curves A-J in which viscosity may decrease with increasing shear rate. The curves are in order of increasing chromium content. For example, curve A has a chromium content of 1.0 grams (g) and curve J has a water content of 35.0 g. Generally, increasing the shear rate can decrease the viscosity of the slurry. Increasing the amount of chromium can decrease the viscosity of the slurry. In some cases, the slurry can have a viscosity from about 1×10⁻² pascal (Pa) second to 100 Pa second at a shear rate from about 0.01 s⁻¹ to 1,000 s⁻¹. For example, the slurry can have a viscosity of 1,000 Pa second at 0.01 s⁻¹. For example, the slurry can have a viscosity of 1×10⁻² Pa second at 1,000 s⁻¹.

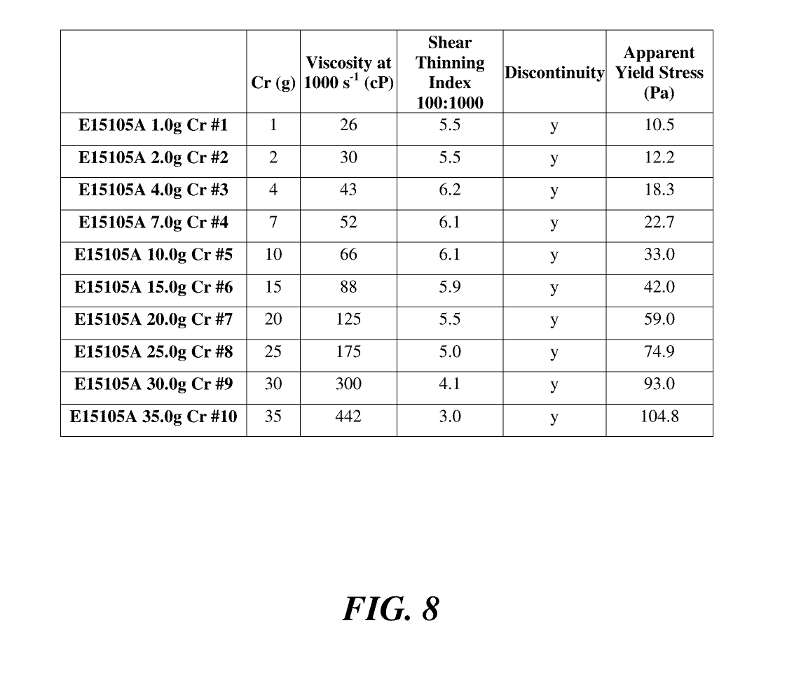

The viscosity, shear thinning index, and yield stress of the slurry can be a function of the weight of an alloying agent in the slurry, such as chromium. FIG. 8 illustrates change in viscosity, shear thinning index, and yield stress as a result of varying amounts of chromium. Generally, increasing the amount of chromium in a slurry can increase the viscosity of the slurry. The increase may be exponential. In some examples, the viscosity of the slurry at a shear rate of 1000 s⁻¹ can be from about 26 centipoise (cP) at a weight of chromium in the slurry of about 1.0 g to 442 cP at a chromium weight of 35.0 g. Generally, increasing the amount of chromium in a slurry can decrease the shear thinning index of the slurry. The decrease may be linear. In some examples, the shear thinning index can be from about 42 (10:1000 s⁻¹) at a weight of chromium in the slurry of about 1.0 g to about 6 at a chromium weight of 35.0 g. In some examples, the shear thinning index can be from about 5.5 (100:1000 s⁻¹) at a weight of chromium in the slurry of about 1.0 g to about 3.0 at a chromium weight of 35.0 g. An increase of weight of chromium in a slurry can increase the yield stress of the slurry. The increase may be linear. In some examples, the yield stress of the slurry can be about 10 pascal (Pa) at a weight of chromium in the slurry of about 1.0 g to about 104 Pa at a chromium weight of 35.0 g.

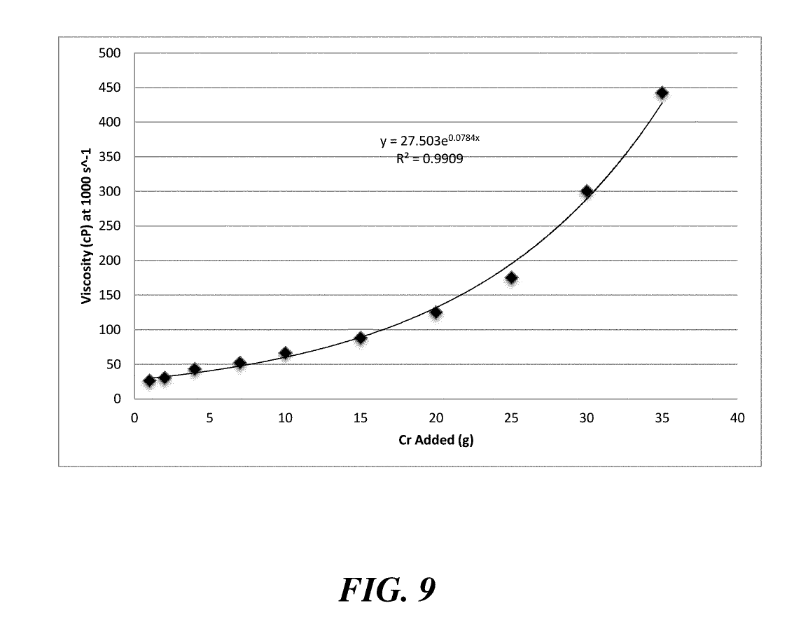

The viscosity of the slurry can be a function of the weight of an alloying agent in the slurry, such as chromium. FIG. 9 illustrates change in viscosity at a fixed shear rate (1000 s⁻¹) as a result of varying amounts of chromium of the slurry. An increase of chromium in a slurry can increase the viscosity of the slurry. The increase may be exponential. In some examples, the viscosity of the slurry at a shear rate of 1000 s⁻¹ can be from about 25 centipoise (cP) at a weight of chromium in the slurry of about 1.0 g to about 450 cP at a chromium weight of 35.0 g.

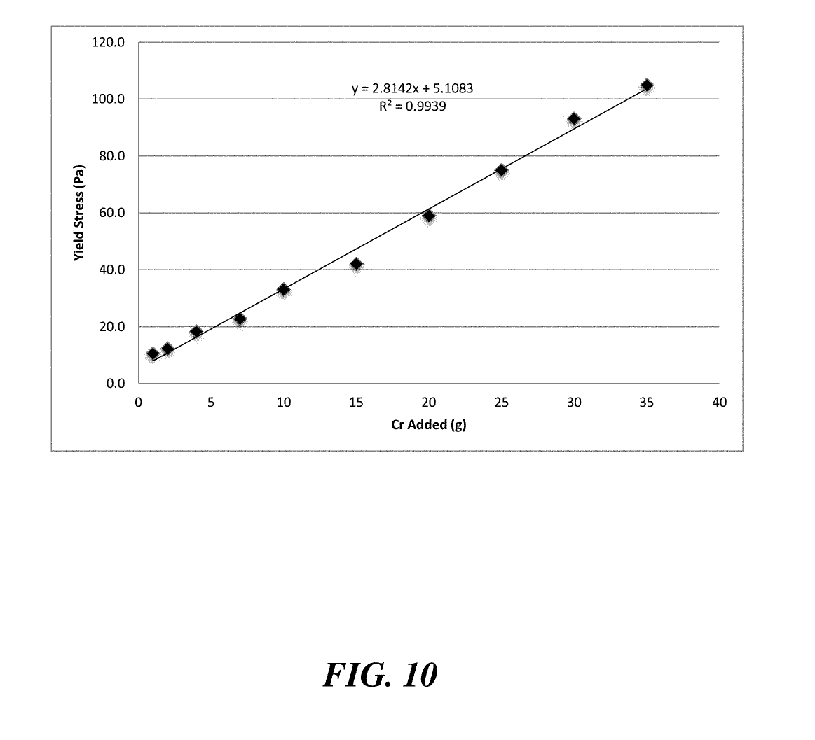

The yield stress of the slurry can be a function of the weight of alloying agent (e.g., chromium) in the slurry. FIG. 10 illustrates change in yield stress as a result of varying amounts of chromium in the slurry. An increase of chromium in the slurry can increase the yield of the slurry. The increase may be linear. In some examples, the yield stress of the slurry can be about 10 pascal (Pa) at a weight of chromium in the slurry of about 1.0 g to about 100 Pa at a chromium weight of 35.0 g.

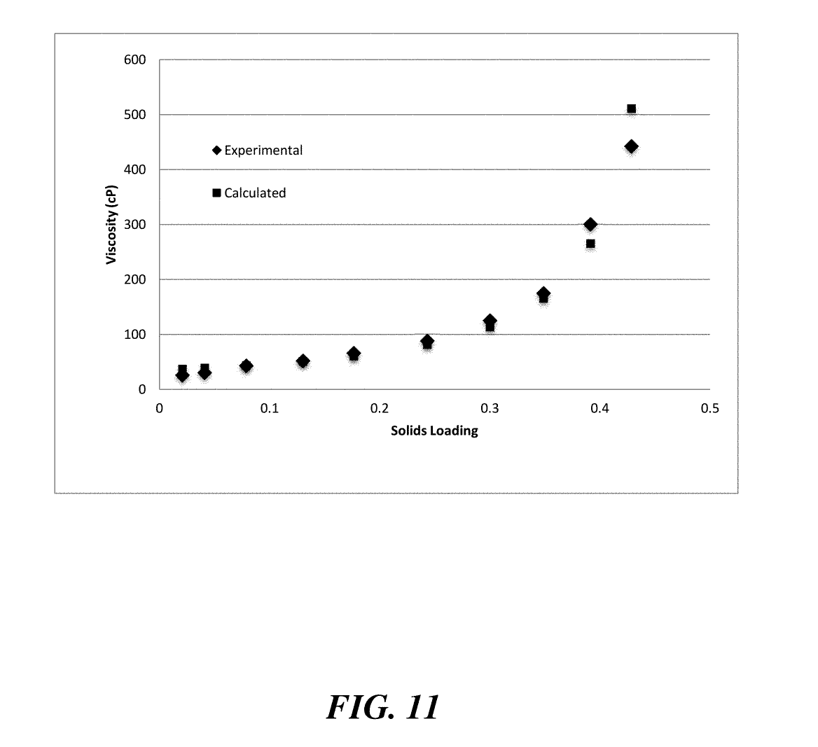

FIG. 11 illustrates experimental data and a calculated Krieger-Dougherty fit of chromium loading to viscosity for a slurry. The experimental data and calculated Krieger-Dougherty fit of chromium loading to viscosity for a slurry may correspond well. An increase of chromium in a slurry can increase the viscosity of the slurry. The increase may be exponential.

### Example 7

Various properties of a slurry can be selected or tailored as desired. Such properties can include viscosity, shear thinning index, and yield stress. In some examples, these properties can change with alumina content.

In another example, a slurry is formed, comprising about 5 g water, 15 g chromium, 0.25 g MgCl₂.H₂O, and alumina in amounts from 4.5 g to 7.5 g in 0.5 g increments. FIG. 12 illustrates change in viscosity, shear thinning index, and yield stress as a result of varying amounts of alumina. Generally, increasing the amount of alumina in a slurry can increase the viscosity of the slurry. The increase may be exponential. In some examples, the viscosity of the slurry at a shear rate of 1000 s⁻¹ can be from about 57 centipoise (cP) at a weight of alumina in the slurry of about 4.5 g to 203 cP at a chromium weight of 7.5 g. Generally, increasing the amount of alumina in a slurry can decrease the shear thinning index of the slurry. In some examples, the shear thinning index can be from about 42 (10:1000 s⁻¹) at a weight of alumina in the slurry of about 4.5 g to about 14 at an alumina weight of 7.5 g. In some examples, the shear thinning index can be from about 5.6 (100:1000 s⁻¹) at a weight of alumina in the slurry of about 4.5 g to about 5.9 at an alumina weight of 7.5 g. An increase of weight of alumina in a slurry can increase the yield stress of the slurry. In some examples, the yield stress of the slurry can be about 26 pascal (Pa) at a weight of alumina in the slurry of about 4.5 g to about 104 Pa at an alumina weight of 7.5 g.

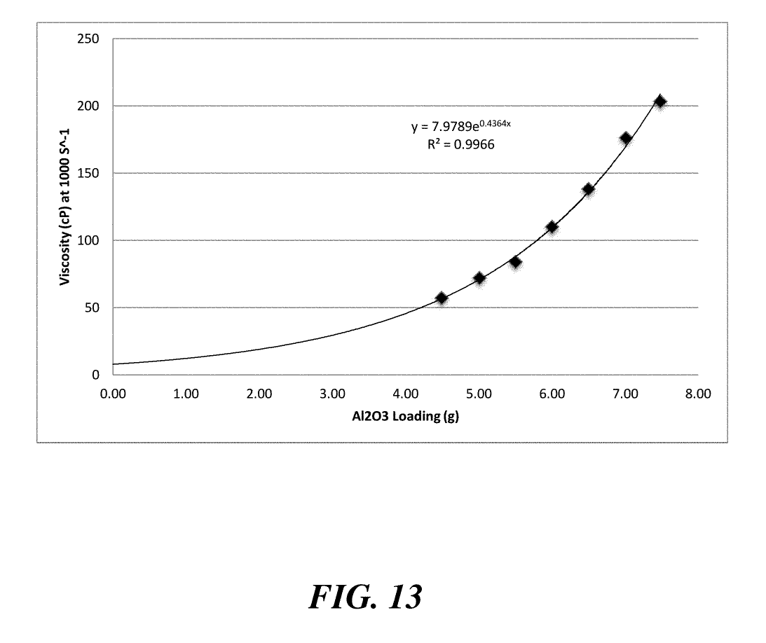

The viscosity of the slurry can be a function of the weight of an inert (e.g. alumina) in the slurry. FIG. 13 illustrates change in viscosity at a fixed shear rate (1000 s⁻¹) as a result of varying amounts of alumina of a slurry. An increase of alumina in a slurry can increase the viscosity of the slurry. The increase may be exponential. In some examples, the viscosity of the slurry at a shear rate of 1000 s⁻¹ can be from about 50 centipoise (cP) at a weight of alumina in the slurry of about 4.5 g to about 200 cP at an alumina weight of 7.5 g. Though not wishing to be bound by mechanistic theory, higher amounts of aluminum (III) oxide in a slurry may interact chemically with the slurry to change structural or physical properties.

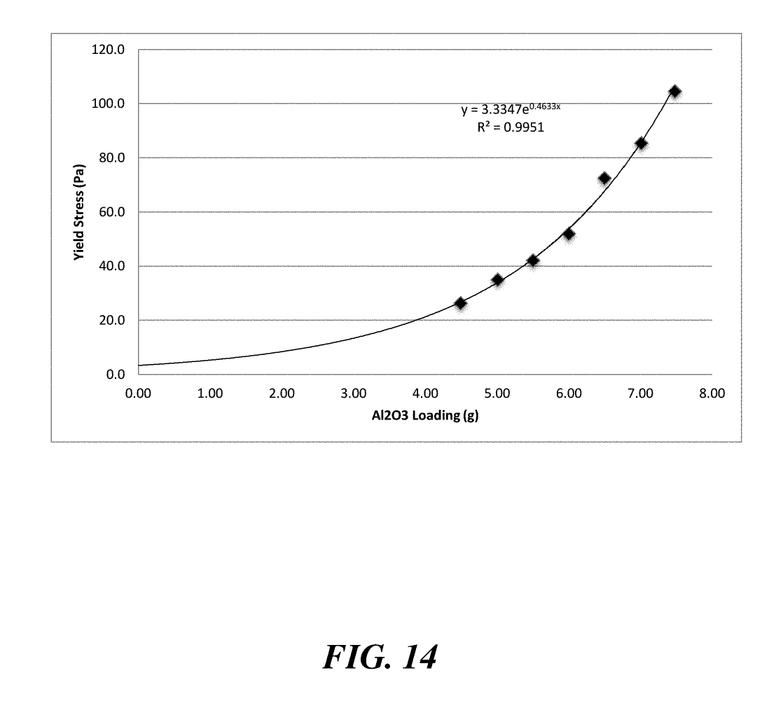

The yield stress of the slurry can be a function of the weight of an inert (e.g. aluminum oxide) in the slurry. FIG. 14 illustrates change in yield stress as a result of varying amounts of aluminum (III) oxide of a slurry. An increase of aluminum (III) oxide in a slurry can increase the yield of the slurry. The increase may be exponential. In some examples, the yield stress of the slurry can be about 25 pascal (Pa) at a weight of alumina in the slurry of about 4.5 g to about 100 Pa at an alumina weight of 7.5 g.

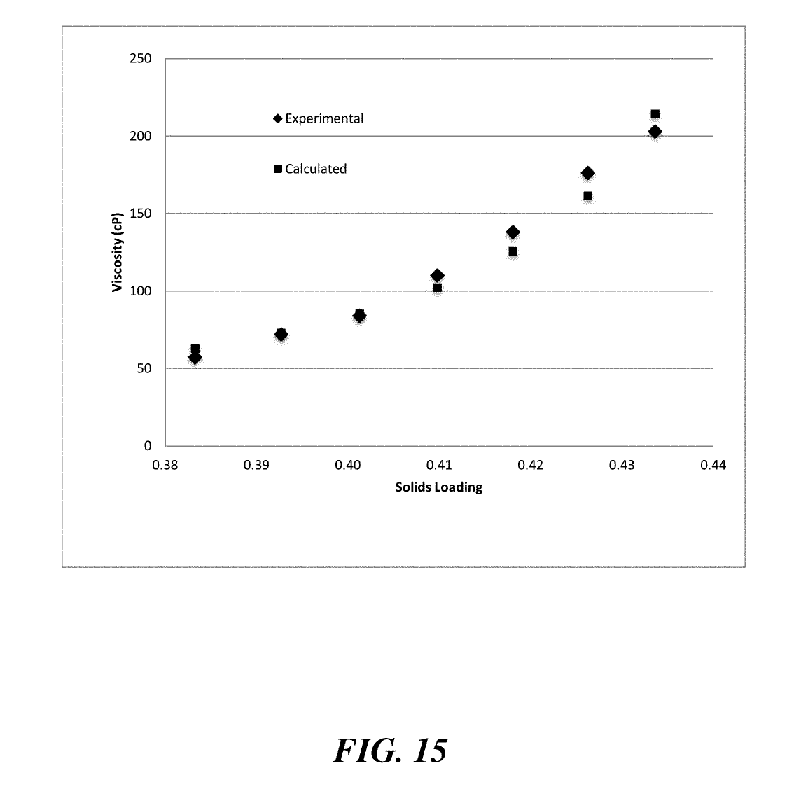

FIG. 15 illustrates a calculated and an experimental Krieger-Dougherty fit of aluminum (III) oxide loading to viscosity for a slurry. The experimental data and calculated Krieger-Dougherty fit of aluminum (III) oxide loading to viscosity for a slurry may correspond well. An increase of aluminum in a slurry can increase the viscosity of the slurry. The increase may be linear or exponential.

### Example 8

Slurry properties can change with the content of an activator (e.g. magnesium chloride). FIG. 16 illustrates change in viscosity, shear thinning index, and yield stress as a result of varying amounts of magnesium chloride. Generally, increasing the amount of magnesium chloride in a slurry can decrease the viscosity of the slurry. The decrease may be exponential or logarithmic. In some examples, the viscosity of the slurry at a shear rate of 1000 s⁻¹ can be from about 93 centipoise (cP) at a weight of magnesium chloride in the slurry of about 0.1 g to 35 cP at a magnesium chloride weight of 4 g. Generally, increasing the amount of magnesium chloride in a slurry can change the shear thinning index of the slurry. In some examples, the shear thinning index can be from about 16 (10:1000 s⁻¹) at a weight of alumina in the slurry of about 0.1 g to about 42 at a magnesium chloride weight of 0.8 g to about 16 at a magnesium chloride weight of 4 g. In some examples, the shear thinning index can be from about 5.8 (100:1000 s⁻¹) at a weight of magnesium chloride in the slurry of about 0.1 g to about 3.1 at a magnesium chloride weight of 4 g. An increase of weight of magnesium chloride in a slurry can decrease the yield stress of the slurry. The decrease may be exponential. In some examples, the yield stress of the slurry can be about 47 pascal (Pa) at a weight of magnesium chloride in the slurry of about 0.1 g to about 4 Pa at a magnesium chloride weight of 4 g.

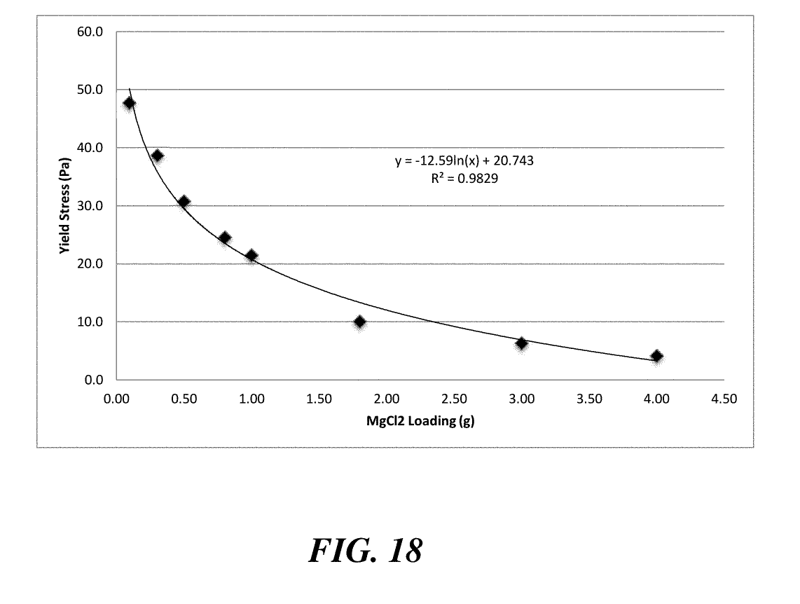

The viscosity of the slurry can be a function of the weight of an activator (e.g. magnesium chloride) in the slurry. FIG. 18 illustrates change in viscosity at a fixed shear rate (1000 s ¹) as a result of varying amounts of magnesium chloride of a slurry. An increase of magnesium chloride in a slurry can decrease the viscosity of the slurry. The decrease may be exponential. In some examples, the viscosity of the slurry at a shear rate of 1000 s⁻¹ can be from about 90 centipoise (cP) at a weight of magnesium chloride in the slurry of about 0.1 g to about 40 cP at a magnesium chloride weight of 4 g.

Physical properties of the slurry can be a function of the amount of activator in the slurry. For example, the yield stress of the slurry can be a function of the weight of magnesium chloride in the slurry. FIG. 18 illustrates change in yield stress as a result of varying amounts of magnesium chloride of a slurry. An increase magnesium chloride in a slurry can decrease the yield of the slurry. The decrease may be exponential. In some examples, the yield stress of the slurry can be about 50 pascal (Pa) at a weight of magnesium chloride in the slurry of about 0.1 g to about 5 Pa at a magnesium chloride weight of 4 g.

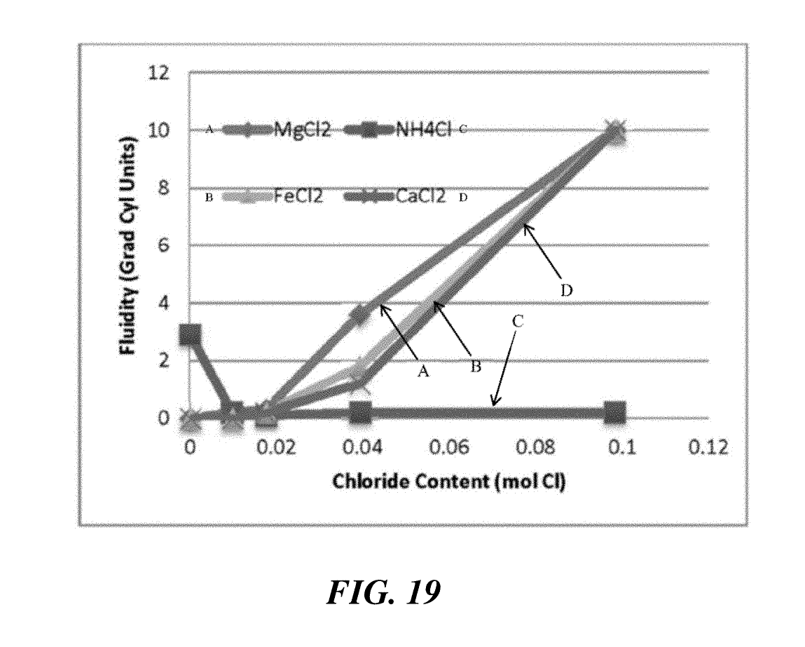

FIG. 19 illustrates the results of a tilt test, where change in fluidity with different chloride sources with varied chloride amounts for a slurry is demonstrated. Higher amounts of magnesium chloride, iron chloride, and calcium chloride in a slurry may correspond with increased fluidity of the slurry. In some examples, 0.1 moles of chloride from magnesium chloride, iron chloride, and calcium chloride can correspond to a fluidity of the slurry of about 10 graduated cylinder units. In some examples, higher amounts of ammonium chloride in a slurry may have little change on the fluidity of the slurry, and 0.1 moles of chloride from ammonium chloride can correspond to a fluidity of the slurry of about 0.5 grad cyl units on a ten milliliter cylinder.

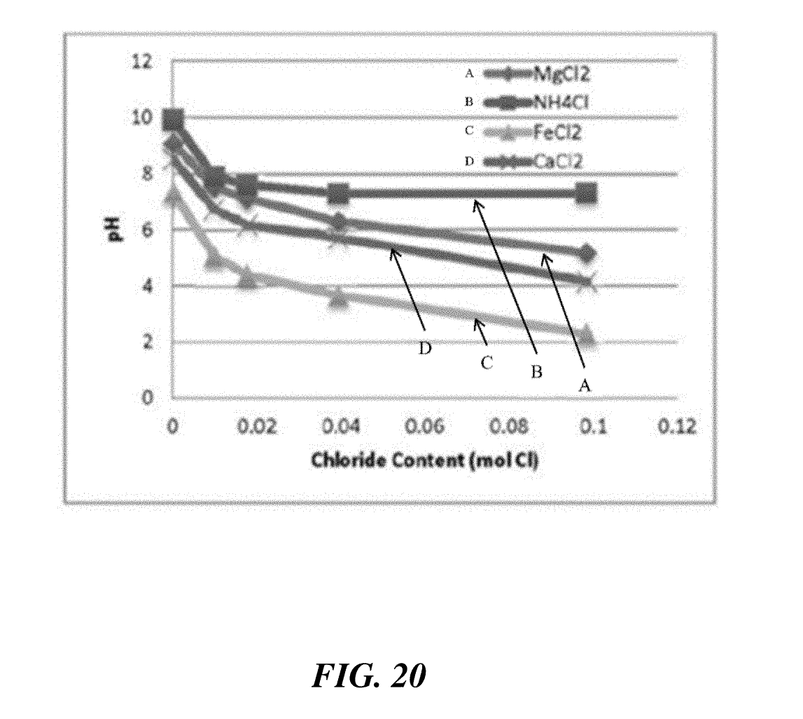

The pH of a slurry may change as a function of the chloride source used in the slurry. FIG. 20 illustrates change in pH with different chloride sources with varying amounts of chloride for a slurry. Higher amounts of magnesium chloride, ammonium chloride, iron chloride, and calcium chloride in a slurry may correspond with a slight decrease in pH of the slurry. In some examples, 0.1 moles of chloride from magnesium chloride, ammonium chloride, iron chloride, and calcium chloride may correspond to a pH of about 5, 7, 2, and 4, respectively.

### Example 9

Physical properties of the slurry may be influence by the identity and content of salts that can be added to the slurry. FIG. 21 illustrates change in fluidity with varying concentrations of magnesium salts for a slurry. Tilt tests of slurries were performed. Generally, higher amounts of magnesium salts, such as magnesium chloride, magnesium acetate, and magnesium sulfate, in a slurry may correspond with an increase in fluidity of the slurry. In some examples, 0.02 moles of magnesium in magnesium sulfate and magnesium acetate can correspond to a fluidity of the slurry of about 6 grad cyl units. In some examples, 0.02 moles of magnesium in magnesium chloride can correspond to a fluidity of the slurry of about 4 grad cyl units.

FIG. 22 illustrates change in pH with various concentrations of magnesium salts for a slurry. Generally, higher amounts of magnesium salts, such as magnesium chloride, magnesium acetate, and magnesium sulfate, in a slurry may correspond with a slight decrease in pH of the slurry. The decrease may be exponential. In some examples, 0.02 moles of magnesium from magnesium chloride, magnesium acetate and magnesium sulfate may correspond to a pH of about 7, 7.5, and 6, respectively.

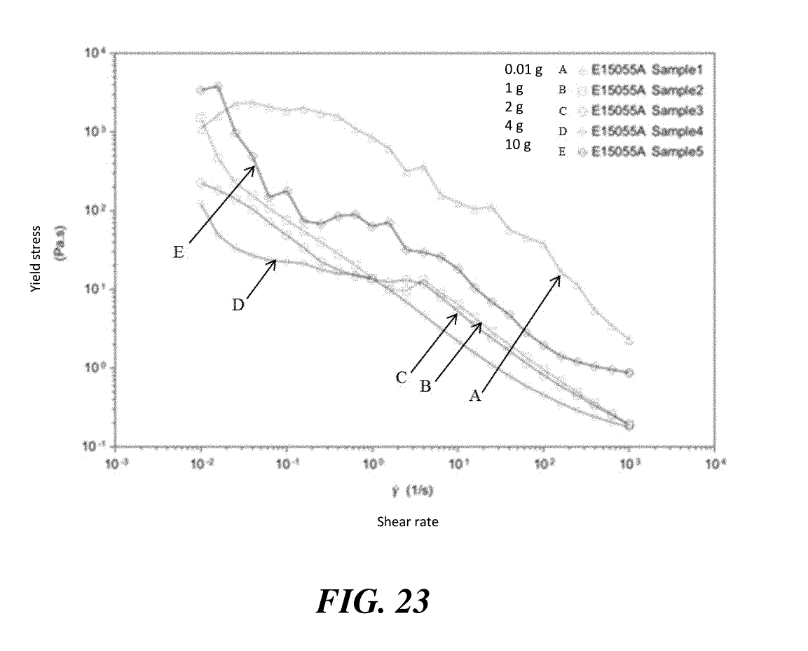

FIG. 23 illustrates change in yield stress with various concentrations and shear rates of magnesium acetate for a slurry. The slurry comprises 15 g chromium, 7.5 g alumina, 5.05 g water, and 0.01 g to 10 g of Mg(OAc)₂.4H₂O. Generally, increasing the shear rate can decrease the yield stress of the slurry. Increasing the amount of magnesium acetate can correspond with a decrease in the yield stress of the slurry until the solubility limit is reached. Monotonic thinning behavior may be observed as more salt is dissolved until the solubility limit is reached. In some examples, the amounts of magnesium acetate in a slurry is about 0.01 g, 1 g, 2 g, 4 g, or 10 g.

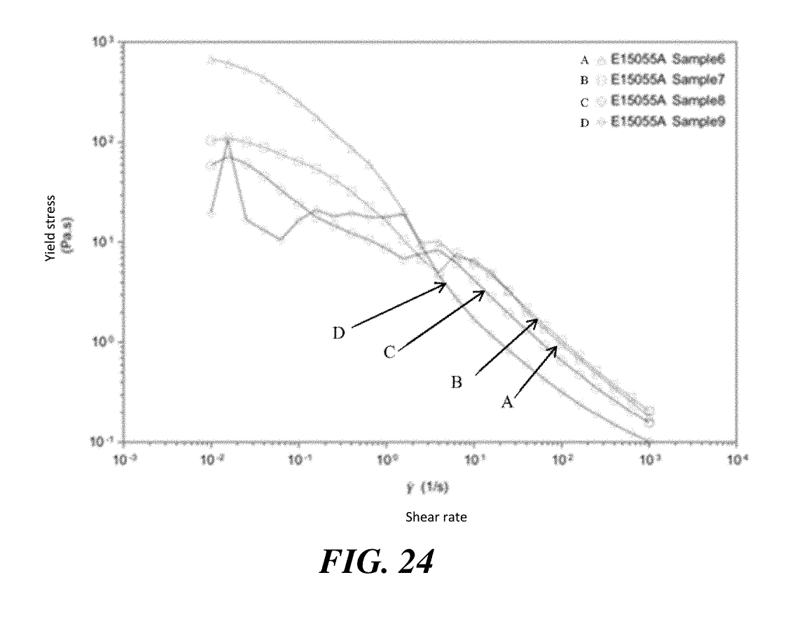

FIG. 24 illustrates change in yield stress with various concentrations and shear rates of magnesium sulfate for a slurry comprising 15 g chromium, 7.5 g alumina, 5.05 g water, and 0.01 g to 10 g of Mg(OAc)₂.7H₂O. A decrease in viscosity as a function of increasing salt is observed. Monotonic thinning behavior may be observed as more salt is dissolved until the solubility limit is reached. 0.0018 g to 0.8000 g MgSO₄ per gram of water in the slurry was used to prepare samples 6-9.

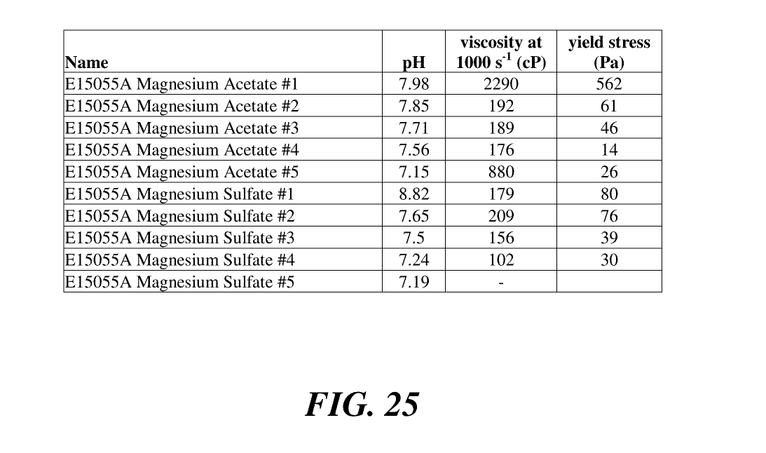

FIG. 25 illustrates change in pH, viscosity, and yield stress with various magnesium salts across a range of concentrations of salts for a slurry.

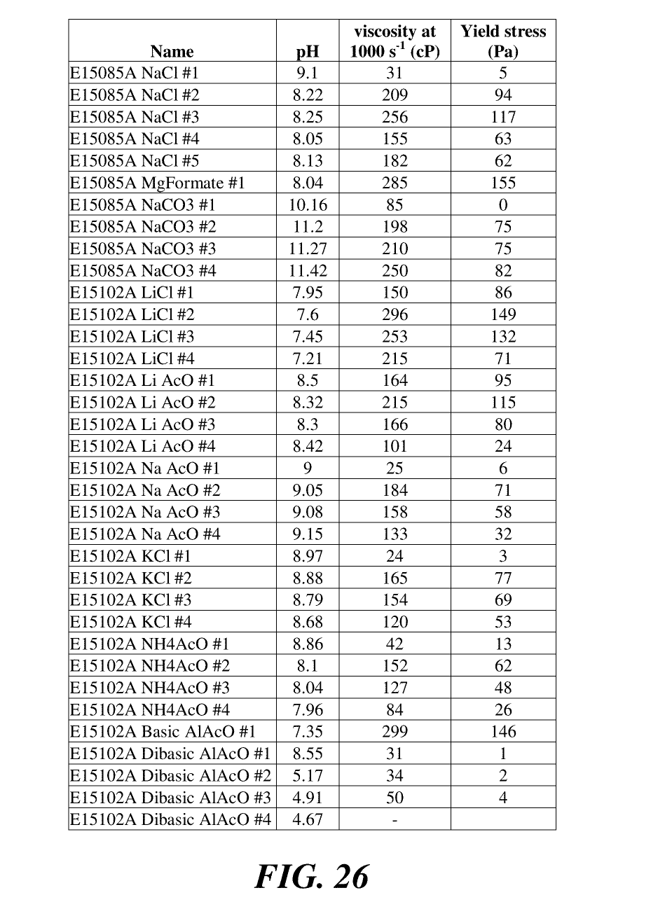

Properties of the slurry, such as pH, viscosity, and yield stress) may be influence by the identity and content of salts that can be added to the slurry. FIG. 26 illustrates change in pH, viscosity, and yield stress with various salts across a range of concentrations of salts for a slurry. Though not wishing to be bound by mechanistic theory, cationic valency may directly influence slurry rheology and ionic strength of salts may not predict slurry rheology. Monovalent acetate salts may be beneficial for target green strength properties. Monovalent salt slurry viscosities may be time dependent at low concentrations. Though not wishing to be bound by mechanistic theory, dibasic aluminum acetate may be added to benefit and remove apparent yield stress in high alumina loading slurries and may demonstrate good cohesion but poor adhesion in green strength tests. In this example, the slurry comprises 15 g chromium, 7.5 g alumina, 5.05 g water, and a varying amount of salt, wherein, #1 refers to 0.1 mmol of salt, #2 refers to 5 mmol of salt, #3 refers to 9 mmol of salt, #4 refers to 20 mmol of salt, and #5 refers to 49 mmol of salt.

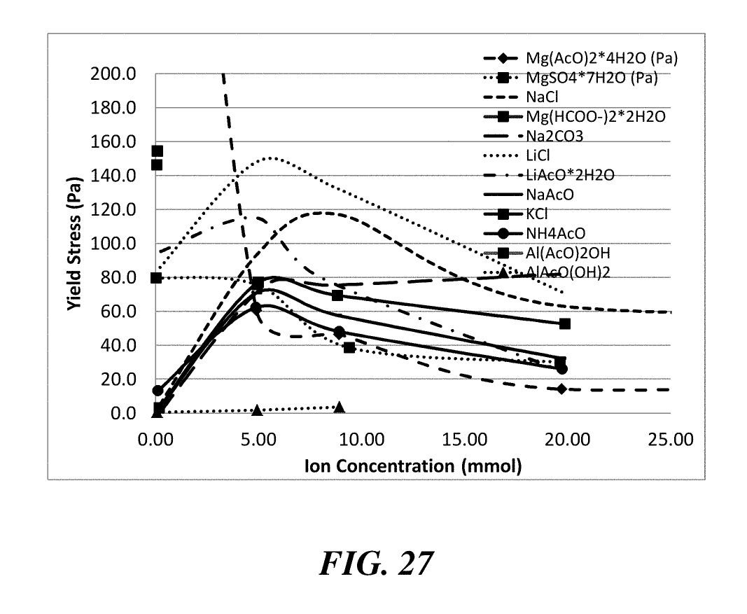

FIG. 27 illustrates change in yield stress as result of various concentrations of ions in a slurry. Generally, magnesium salts initially have high yield stresses and then demonstrate thinning. Generally, monovalent salts demonstrate thickening upon addition of more salt before slight thinning at even higher concentrations. Generally, trivalent salts and dibasic aluminum acetate show little to no yield stress at a solution concentration.

### Example 10

In another example, substrates are provided comprising carbon, silicon, manganese, titanium, vanadium, aluminum, and nitrogen. In an example, the following substrates comprise at least the following components, in wt %:

| Substrate | C | Si | Mn | Ti | V | Al | N |
|---|---|---|---|---|---|---|---|
| SDI-01 | 0.039 | 0.32 | 0.523 | 0.169 | 0.01 | 0.049 | 0.0081 |
| SDI-03 | 0.035 | 0.333 | 0.634 | 0.281 | 0.018 | 0.059 | 0.0051 |
| SDI-04 | 0.032 | 0.321 | 0.592 | 0.245 | 0.015 | 0.03 | 0.0065 |
| C6 | 0.029 | 0.0017 | 0.52 | 0.018 | 0.0008 | 0.0095 | 0.007 |
| C13 | 0.007 | 0.016 | 1.6 | 0.019 | 0.11 | 0.0012 | 0.012 |
| C20 | 0.007 | 0.02 | 1.25 | 0.015 | 0 | 0.006 | 0.008 |
| C21 | 0.004 | 0.02 | 1.24 | 0.014 | 0.09 | 0.011 | 0.009 |

Substrates SDI-01 and C6 are examples of substrates in which chromium carbide is formed on the surface of the layer adjacent to the substrate after the substrate is coated with a slurry and annealed. Substrates SDI-03, SDI-04, C13, C20 and C21 are examples of substrates in which chromium carbide is not formed on the surface of the layer adjacent to the substrate after the substrate is coated with a slurry and annealed. For substrates SDI-03, SDI-04, C13, C20 and C21, chromium carbide may form if processing conditions are selected to facilitate the formation of the chromium carbide, such as if the slurry is applied in a pattern or morphology that facilitates the formation of chromium carbide.

### Example 11

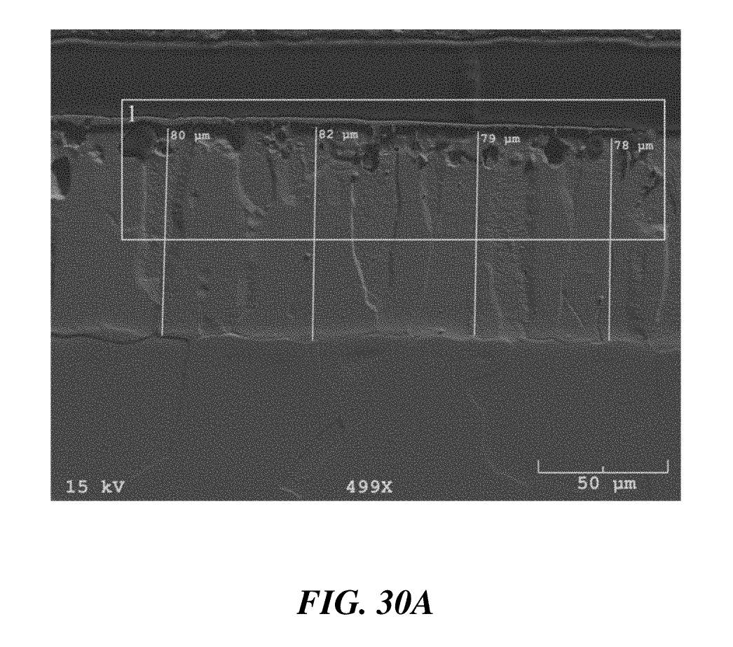

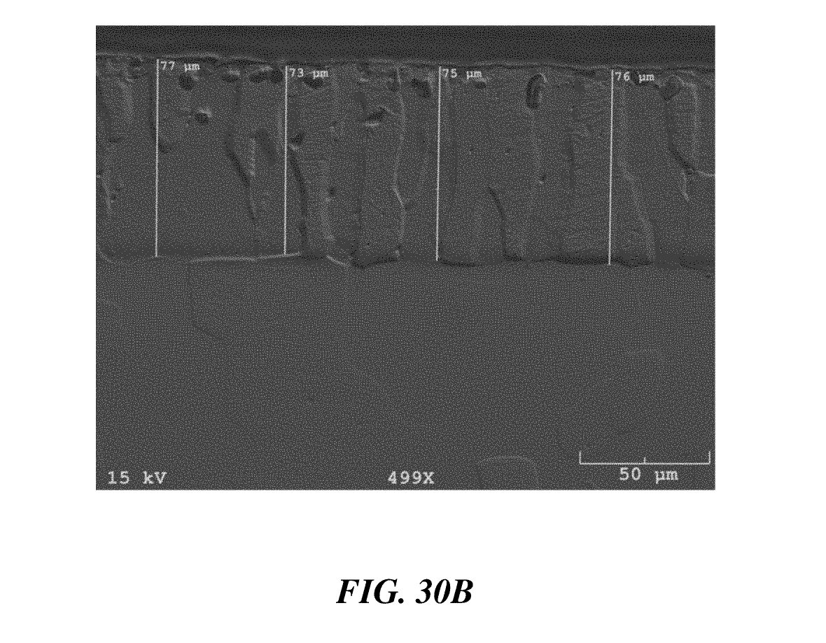

In another example, the appearance of a layer adjacent to a substrate is influenced by the identity of the elements of the substrate. FIG. 30A shows a cross section of the layer adjacent to the substrate after a slurry has been annealed adjacent to the substrate. Chromium carbide is present on the surface of the layer. The surface of the layer is rich in chromium and carbon. The layer has streaks alternating between a dull finish and a shiny finish. In contrast, FIG. 30B shows a cross section of the layer adjacent to a substrate after a slurry has been annealed adjacent to the substrate. Chromium carbide is not present on the surface of the layer. The layer is shiny in appearance.

Materials, devices, systems and methods herein, including material compositions (e.g., material layers), can be combined with or modified by other materials, devices, systems and methods, including material compositions, such as, for example, those described in U.S. Patent Publication No. 2013/0171471; U.S. Patent Publication No. 2013/0309410; U.S. Patent Publication No. 2013/0252022; U.S. Patent Publication No. 2015/0167131; U.S. Patent Publication No. 2015/0345041, and Patent Cooperation Treaty Application No. PCT/US2016/017155, each of which is incorporated herein by reference in its entirety.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-55. (canceled)

56. A method for forming a metal-containing part, comprising:
(a) providing a substrate comprising carbon at a concentration of at least about 0.001 wt. % as measured by x-ray photoelectron spectroscopy (XPS);
(b) using a slurry to deposit a first layer comprising at least one metal adjacent to said substrate, wherein said at least one metal is selected from chromium and nickel; and
(c) subjecting said first layer and said substrate to annealing under conditions that are sufficient to generate a second layer from said first layer adjacent to said substrate, wherein said second layer comprises said carbon and said at least one metal as a metal carbide, thereby forming said metal-containing part comprising said second layer and said substrate, wherein said second layer comprises domains of said metal carbide and domains without said metal carbide.

57. The method of claim 56, wherein said at least one metal comprises chromium.

58. The method of claim 56, wherein said at least one metal comprises nickel.

59. The method of claim 56, wherein said at least one metal comprises chromium and nickel.

60. The method of claim 56, wherein said slurry comprises an alloying agent, a metal halide activator and a solvent, and wherein said alloying agent comprises said metal.

61. The method of claim 60, wherein said alloying agent comprises carbon.

62. The method of claim 60, wherein said metal halide activator comprises a monovalent metal, a divalent metal or a trivalent metal.

63. The method of claim 56, wherein said substrate comprises steel.

64. The method of claim 56, wherein said first layer has a pattern or morphology that facilitates formation of said metal carbide.

65. The method of claim 56, wherein said second layer is an outermost layer.

66. The method of claim 56, wherein in (a), said carbon is at a concentration of at least about 0.01 wt. % as measured by XPS.

67. The method of claim 56, wherein in (a), said carbon is at a concentration of at least about 0.1 wt. % as measured by XPS.

68. A method for forming a metal layer adjacent to a substrate, comprising:
(a) providing a substrate comprising carbon at a concentration of at least about 0.001 wt. % as measured by x-ray photoelectron spectroscopy (XPS);
(b) using a slurry to deposit a first layer comprising at least one metal adjacent to said substrate, wherein said slurry has a viscosity from about 1 centipoise (cP) to 200 cP at a shear rate of shear rate of 1000 s⁻¹; and
(c) subjecting said first layer and said substrate to annealing under conditions that are sufficient to generate a second layer from said first layer adjacent to said substrate, wherein said second layer comprises said carbon and said at least one metal as a metal carbide, thereby forming said metal-containing part comprising said second layer and said substrate, wherein said second layer comprises domains of said metal carbide and domains without said metal carbide.

69. The method of claim 68, wherein said slurry comprises an alloying agent, a metal halide activator and a solvent, and wherein said alloying agent comprises said metal.

70. The method of claim 69, wherein said alloying agent comprises carbon.

71. The method of claim 69, wherein said metal halide activator comprises a monovalent metal, a divalent metal or a trivalent metal.

72. The method of claim 68, wherein said substrate comprises steel.

73. The method of claim 68, wherein said first layer has a pattern or morphology that facilitates formation of said metal carbide.

74. The method of claim 68, wherein said slurry has a viscosity from about 1 centipoise (cP) to 150 cP at a shear rate of shear rate of 1000 s⁻¹.

75. The method of claim 68, wherein said second layer is an outermost layer.
